(19) United States
(12) Patent Application Publication
(10) Pub. No.: US 2025/0065336 A1
(43) Pub. Date: Feb. 27, 2025

(54) MOLECULAR DIAGNOSTIC DEVICES AND METHODS

(71) Applicant: VISBY MEDICAL, INC., San Jose, CA (US)

(72) Inventors: Brian CIOPYK, Los Gatos, CA (US); Boris ANDREYEV, Foster City, CA (US); Victor BRIONES, Gilroy, CA (US); David CHAU, San Jose, CA (US); Kamal KAJOUKE, San Jose, CA (US); Shaunak ROY, Sunnyvale, CA (US)

(73) Assignee: VISBY MEDICAL, INC., San Jose, CA (US)

(21) Appl. No.: 18/751,822

(22) Filed: Jun. 24, 2024

Related U.S. Application Data
(60) Provisional application No. 63/534,790, filed on Aug. 25, 2023.

(51) Int. Cl. B01L 7/00; G01N 1/44

(52) U.S. Cl. CPC B01L 7/52; G01N 1/44; B01L 2200/147; B01L 2300/123; B01L 2300/1827

(57) ABSTRACT

An apparatus includes a housing and a sample preparation module disposed within the housing. The sample preparation module has a base including a wall defining a sample reservoir. The apparatus includes a flexible heater having a first end and a second end. The first end of the flexible heater is coupled to a connector to be in electrical communication with a power source. A carrier is coupled to and supports the flexible heater such that the second end of the flexible heater is disposed within the sample reservoir spaced apart from the wall. The apparatus can also include an input retention lid that can be disposed partially within the sample reservoir and includes a retention screen to prevent solid reagents within the sample reservoir from migrating upward.

### CROSS-REFERENCE TO RELATED APPLICATIONS

This application claims benefit of priority to U.S. Provisional Application Ser. No. 63/534,790, entitled “Molecular Diagnostic Devices and Methods,” filed Aug. 25, 2023, which is incorporated herein by reference in its entirety.

### STATEMENT REGARDING FEDERALLY SPONSORED RESEARCH OR DEVELOPMENT

This invention was made with government support under Biomedical Advanced Research and Development Authority (BARDA) Contract No. 75A50121C00019 awarded by the Department of Health and Human Services. The government has certain rights in the invention.

### BACKGROUND

The embodiments described herein relate to devices and methods for molecular diagnostic testing. More particularly, the embodiments described herein relate to disposable, self-contained devices and methods for molecular diagnostic testing.

There are over one billion infections in the U.S. each year, many of which are treated incorrectly due to inaccurate or delayed diagnostic results. Many known point of care (POC) tests have poor sensitivity (30-70%), while the more highly sensitive tests, such as those involving the specific detection of nucleic acids or molecular testing associated with a pathogenic target, are only available in laboratories. Thus, molecular diagnostics testing is often practiced in centralized laboratories. Known devices and methods for conducting laboratory-based molecular diagnostics testing, however, require trained personnel, regulated infrastructure, and expensive, high throughput instrumentation. Known high throughput laboratory equipment generally processes many (96 to 384 and more) samples at a time, therefore central lab testing is often done in batches. Known methods for processing test samples typically include processing all samples collected during a time period (e.g., a day) in one large run, resulting in a turn-around time of many hours to days after the sample is collected. Moreover, such known instrumentation and methods are designed to perform certain operations under the guidance of a skilled technician who adds reagents, oversees processing, and moves a biological sample from step to step. Thus, although known laboratory tests and methods are very accurate, they often take considerable time, and are very expensive.

Although some known laboratory-based molecular diagnostics test methods and equipment offer flexibility (e.g., the ability to test for multiple different indications), such methods and equipment are not easily adaptable for point of care (“POC”) use or in-home use by an untrained user. Specifically, such known devices and methods are complicated to use and include expensive and sophisticated components. Thus, the use of such known laboratory-based methods and devices in a decentralized setting (e.g., POC or in-home use) would likely result in an increase in misuse, leading to inaccurate results or safety concerns. For example, many known laboratory-based systems include sophisticated optics and laser light sources, which can present a safety hazard to an untrained user. Some known systems can also require the user to handle or be exposed to reagents, which can be a safety risk for an untrained user. For example, some known systems use relatively large amounts of reagents and/or require replenishment of the reagents (e.g., within an instrument). In addition to being unsuitable for decentralized use, these known systems are also not suitable for long-term storage and shipping. Long-term storage can be desirable, for example to allow for stockpiling of assays for military applications, as a part of the CDC strategic national stockpile program, or other emergency preparedness initiatives.

Moreover, because of the flexibility offered by many known laboratory-based systems, such systems do not include lock-outs or mechanisms that prevent an untrained user from completing certain actions out of the proper sequence. For example, many known systems and methods include several distinct sample preparation operations, such as filtering, washing, lysing, and addition of sample preparation reagents to preserve the target nucleic acids. If such operations are not performed in a predetermined order and/or within predetermined time limits, the accuracy of the test can be compromised. Some known systems attempt to limit the complexities associated with sample preparation by limiting the analysis to only “clean” samples. As a result, such systems do not enable true end-to-end molecular diagnostic methods, because the detailed sample preparation must still be performed by an upstream process.

There are other potential concerns with performing decentralized testing (e.g., testing at a point-of-care, a patient's home, work sites, or other public venues) that may lead to reduced performance (e.g., reduced specificity and sensitivity, greater incidents of aborted tests, etc.). For example, test components that are shipped and stored in standard channels of commerce and/or that are used outside of a laboratory setting may be subjected to extreme ambient conditions (temperatures, pressures), vibration, change in orientation or the like. As such, pre-loaded reagents may be at a greater risk of being compromised (e.g., leaking or falling out of their container). Additionally, ensuring that all reagents and solutions are properly mixed during the administration of the test can be problematic outside of a laboratory environment. Furthermore, decentralized testing in small handheld devices (e.g., testing at a point-of-care, a patient's home, work sites, or other public venues) may lead to reduced performance due to improper mixing of biological samples reagents.

In addition to requiring sufficient accuracy, cost and availability is another important factor in implementing decentralized testing. For example, it is desirable to establish high volume manufacturing for test components (e.g., to increase availability and decrease cost). Such components or devices, however, can exhibit part-to-part variability (e.g., due to normal manufacturing tolerances), which can impact the overall performance. For example, variability in positioning of a detection system relative to a sample can result in undesirable variation in results.

Multiplex tests (i.e., test devices or systems that can detect multiple different target nucleic acids) are another important tool in providing a more comprehensive diagnosis without requiring multiple different patient visits, sample collection events, or test components. For example, some known multiplex tests can screen for multiple different indications (e.g., COVID-19 and multiple variants of influenza). Multiplex tests, however, generally require a higher volume of a biological sample to test for multiple targets. Such known multiplex tests can also require a greater amount of reagents (buffer solutions, PCR enzymes, or the like), which can increase costs.

Further in some known devices, a biological sample is heated to a desired temperature using a heating element placed below an intermediate component adjacent to the fluid to be heated. Such systems can waste energy due to the need to first heat the intermediate component in addition to the sample. In addition, in such systems there is an offset between the temperature of the heating element and the actual temperature experienced by the fluid. Thus, a need exists for new and improved methods for heating a biological sample that provides a more accurate and efficient measure of temperature.

Further, it can be desirable to control the instantaneous power consumption of a molecular diagnostic test device to allow the device to operate using a variety of different power sources. It is also desirable to have an inexpensive and efficient mechanism for determining the power source to which the device is coupled.

Thus, a need exists for improved devices and methods for molecular diagnostic testing. In particular, a need exists for improved devices and methods that can be manufactured at lower cost while still providing sufficient accuracy of testing.

### SUMMARY

Molecular diagnostic test devices for producing an indicator of a target molecule (e.g., DNA or RNA) in the sample are described herein. In accordance with some embodiments, an apparatus includes a housing and a sample preparation module disposed within the housing. The sample preparation module has a base including a wall defining a sample reservoir. The apparatus includes a flexible heater having a first end and a second end. The first end of the flexible heater is coupled to a connector to be in electrical communication with a power source. A carrier is coupled to and supports the flexible heater such that the second end of the flexible heater is disposed within the sample reservoir spaced apart from the wall.

In accordance with some embodiments, a method includes introducing a biological sample into a sample reservoir of a sample preparation module. The sample preparation module has a wall defining the sample reservoir. A flexible heater disposed within the sample reservoir is actuated to heat the biological sample. A processor coupled to the flexible heater measures a resistance change of the flexible heater. The processor approximates a change in temperature within the sample reservoir based on the measured resistance change of the flexible heater. The processor adjusts a current supplied to the flexible heater based on the approximating the change in temperature.

In accordance with some embodiments, a method includes coupling a USB connector to an electronic device. At the electronic device a voltage across a configuration channel (CC) pin resistor of the electronic device is measured. The electronic device identifies a power capability of the USB connector based on the measured voltage across the CC pin resistor. Based on the power capability, the method includes enabling at the electronic device to make power from the USB connector available to the electronic device. In some embodiments, the method includes enabling the electronic device via an electronic load switch.

In accordance with some embodiments, a method includes coupling a USB Type-C connector to an electronic device. At a first comparator a first voltage of a first configuration channel (CC) pin associated with the USB Type-C connector and a reference voltage are received. When the first voltage exceeds the reference voltage, the first comparator outputs a first signal. At a second comparator a second voltage of a second CC pin associated with the USB Type-C connector and the reference voltage are received. When the second voltage exceeds the reference voltage, the second comparator outputs a second signal. At a logical OR gate, an output from the first comparator and an output from second comparator are received. When the logical OR gate receives one of the first signal and the second signal, the logical OR gate produces an output voltage. The output voltage of the logical OR gate is received at an R-C time delay circuit. When the output voltage of the R-C time delay circuit exceeds a threshold voltage, an electronic load switch of the electronic device is enabled such that power from the USB Type-C connector becomes available to the electronic device.

### BRIEF DESCRIPTION OF THE DRAWINGS

FIG. 1 is a schematic illustration of a portion of a molecular diagnostic test device, according to an embodiment.

FIG. 2A is a flowchart of a method of measuring a temperature within a sample reservoir of a molecular diagnostic test device, according to an embodiment.

FIGS. 2B and 2C are each a schematic illustration of an example electronic system according to two different embodiments.

FIG. 3 is a flowchart of a method of detecting a USB connector connected to the molecular diagnostic test device, according to an embodiment.

FIG. 4 is a flowchart of a method of detecting a USB connector connected to the molecular diagnostic test device, according to another embodiment.

FIG. 5A is a schematic illustration of a portion of an electronic control system of a molecular diagnostic test device, according to an embodiment.

FIG. 5B is a schematic illustration of a portion of a molecular diagnostic test device according to an embodiment.

FIG. 6 is a diagram illustrating an enzyme linked reaction, according to an embodiment, resulting in the production of a signal.

FIGS. 7A and 7B are a perspective view and a top view, respectively, of a molecular diagnostic test device, according to an embodiment.

FIG. 8A is a perspective view of the molecular diagnostic test device of FIGS. 7A and 7B, shown with the top portion of the housing removed for illustration purposes.

FIG. 8B is a partial exploded view of the molecular diagnostic device of FIG. 8A, shown with the top portion of the housing removed for illustration purposes.

FIG. 8C is a partial exploded view of the molecular diagnostic device of FIG. 8A with select components removed for illustration purposes.

FIG. 9A is a bottom perspective view of the lid of the molecular diagnostic device of FIG. 8A, and FIG. 9B is a top perspective view of the lid of the molecular diagnostic device of FIG. 8A.

FIG. 10A is an enlarged view of a portion of the molecular diagnostic test device of FIG. 8, with the top portion of the housing removed.

FIG. 10B is an exploded view of a portion of the sample preparation module of the molecular diagnostic test device shown in FIG. 10A.

FIG. 11 is a cross-sectional view taken along line 11-11 in FIG. 7B.

FIG. 12 is a cross-sectional view taken along line 12-12 in FIG. 7B.

FIG. 13 is a cross-sectional view taken along line 13-13 in FIG. 7A with the input retention lid removed for illustration purposes.

FIG. 14A is a top perspective view of the molecular diagnostic test device of FIGS. 7A and 7B with the top portion of the housing and select components removed for illustration purposes.

FIG. 14B is an enlarged view of a portion of the molecular diagnostic test device shown in FIG. 14A.

FIG. 14C is an enlarged view of a portion of the molecular diagnostic test device shown in FIG. 14A.

FIG. 15 is a side perspective view of a portion of the molecular diagnostic test device of FIGS. 7A and 7B with the top portion and the bottom portion of the housing removed for illustration purposes.

FIG. 16 is a partial exploded view of the molecular diagnostic test device of FIGS. 7A and 7B with the top portion and the bottom portion of the housing removed for illustration purposes.

FIGS. 17 and 18 are an exploded view from the bottom perspective (FIG. 17) and the top perspective (FIG. 18) of the amplification module and detection module of the molecular diagnostic test device of FIGS. 7A and 7B.

FIG. 19 is a perspective view of a heat sink of the molecular diagnostic test device of FIGS. 7A and 7B.

FIG. 20A-20C are perspective views of the molecular diagnostic device shown in FIGS. 7A and 7B in various stages of operation, according to an embodiment.

FIG. 21 is a rear perspective view of the molecular diagnostic device shown in FIGS. 7A and 7B, illustrating an electrical port.

FIG. 22 is a graph illustrating an example power consumption versus time of a USB-C connector coupled to a molecular diagnostic test device.

FIG. 23 is a perspective view of a portion of a molecular diagnostic device according to another embodiment.

### DETAILED DESCRIPTION

In some embodiments, an apparatus is configured for a disposable, portable, single-use, inexpensive, molecular diagnostic approach. The apparatus can include one or more modules configured to perform high quality molecular diagnostic tests, including, but not limited to, sample preparation, nucleic acid amplification (e.g., via polymerase chain reaction, isothermal amplification, or the like), and detection.

In some embodiments, the devices described herein are stand-alone devices that include all necessary substances, mechanisms, and subassemblies to perform any of the molecular diagnostic tests described herein. Such stand-alone devices do not require any external instrument to manipulate the biological samples, and only require connection to a power source (e.g., a connection to an A/C power source, coupling to a battery, or the like) to complete the methods described herein. For example, the device described herein do not require any external instrument to heat the sample, agitate or mix the sample, to pump (or move) fluids within a flow member, or the like. Rather, the embodiments described herein are fully-contained and upon loading a biological sample and being coupled to a power source, the device can be actuated to perform the molecular diagnostic tests described herein. In some embodiments, the method of actuating the device can be such that the device is a CLIA-waived device and/or can operate in accordance with methods that are CLIA waived.

As used in this specification and the appended claims, the term “reagent” includes substance that is used in connection with any of the reactions described herein. For example, a reagent can include an elution buffer, a PCR reagent, an enzyme, a substrate, a wash solution, a blocking solution, or the like. A reagent can include a mixture of one or more constituents. A reagent can include such constituents regardless of their state of matter (e.g., solid, liquid or gas). Moreover, a reagent can include the multiple constituents that can be included in a substance in a mixed state, in an unmixed state and/or in a partially mixed state. A reagent can include both active constituents and inert constituents. Accordingly, as used herein, a reagent can include non-active and/or inert constituents such as water, colorant or the like.

The term “nucleic acid molecule,” “nucleic acid,” or “polynucleotide” may be used interchangeably herein and may refer to deoxyribonucleic acid (DNA) or ribonucleic acid (RNA), including known analogs or a combination thereof unless otherwise indicated. Nucleic acid molecules to be profiled herein can be obtained from any source of nucleic acid. The nucleic acid molecule can be single-stranded or double-stranded. In some cases, the nucleic acid molecules are DNA. The DNA can be mitochondrial DNA, complementary DNA (cDNA), or genomic DNA. In some cases, the nucleic acid molecules are genomic DNA (gDNA). The DNA can be plasmid DNA, cosmid DNA, bacterial artificial chromosome (BAC), or yeast artificial chromosome (YAC). The DNA can be derived from one or more chromosomes. For example, if the DNA is from a human, the DNA can be derived from one or more of chromosomes 1, 2, 3, 4, 5, 6, 7, 8, 9, 10, 11, 12, 13, 14, 15, 16, 17, 18, 19, 20, 21, 22, X, or Y. In some cases, the nucleic acid molecules are RNA can include, but is not limited to, mRNAs, tRNAs, snRNAs, rRNAs, retroviruses, small non-coding RNAs, microRNAs, polysomal RNAs, pre-mRNAs, intronic RNA, viral RNA, cell free RNA and fragments thereof. The non-coding RNA, or ncRNA can include snoRNAs, microRNAs, siRNAs, piRNAs and long nc RNAs. The source of nucleic acid for use in the devices, methods, and compositions described herein can be a sample comprising the nucleic acid.

Unless indicated otherwise, the terms apparatus, diagnostic apparatus, diagnostic system, diagnostic test, diagnostic test system, test unit, and variants thereof, can be interchangeably used.

The methods described herein can be performed on any suitable molecular diagnostic device, such as any of the diagnostic devices shown and described herein or in International Patent Publication No. WO2016/109691, entitled “Devices and Methods for Molecular Diagnostic Testing,” International Patent Publication No. WO2017/185067, entitled “Printed Circuit Board Heater for an Amplification Module,” International Patent Publication No. WO2018/005710, entitled “Devices and Methods for Detection of Molecules Using a Flow Cell,” and International Patent Publication No. WO2018/005870, entitled “Devices and Methods for Nucleic Acid Extraction,” International Patent Publication No. WO2020/223257A1 entitled “Molecular Diagnostic Devices with Digital Detection Capability and Wireless Connectivity,” International Patent Publication No. WO2021/138544A1 entitled “Devices and Methods for Antibiotic Susceptibility Testing,” U.S. Patent Publication No. US2019/0169677, entitled “Portable Molecular Diagnostic Device and Methods for Detection of Target Viruses.” each of which is incorporated herein by reference in its entirety.

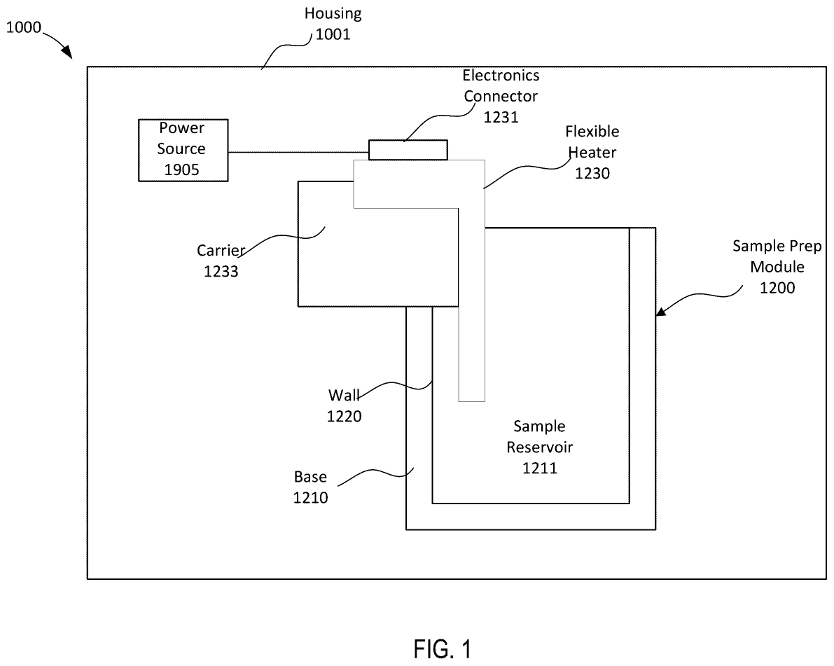

FIG. 1 is a schematic illustrations of a molecular diagnostic test device 1000 (also referred to as a “test device” or “device”), according to an embodiment. The test device 1000 is configured to manipulate a biological sample to produce one or more output signals associated with a target cell, according to the various systems and the methods described herein. In some embodiments, the test device 1000 can be an integrated device that is suitable for use within a point-of-care setting (e.g., doctor's office, pharmacy or the like), decentralized test facility, or at the user's home. Similarly stated, in some embodiments, the modules of the device, described below, are contained within a single housing such that the test device can be fully operated without any additional instrument, docking station, or the like. Further, in some embodiments, the test device 1000 can have a size, shape and/or weight such that the test device 1000 can be carried, held, used and/or manipulated in a user's hands (i.e., it can be a “handheld” device). In some embodiments, the test device 1000 can be a self-contained, single-use device.

In some embodiments, the test device 1000 (and any of the devices shown and described herein) can be a CLIA-waived device and/or can operate in accordance with methods that are CLIA waived. Similarly stated, in some embodiments, the test device 1000 (and any of the other devices shown and described herein) is configured to be operated in a sufficiently simple manner and can produce results with sufficient accuracy to pose a limited likelihood of misuse and/or to pose a limited risk of harm if used improperly. In some embodiments, the test device 1000 (and any of the other devices shown and described herein), can be operated by a user with minimal (or no) scientific training, in accordance with methods that require little judgment of the user, and/or in which certain operational steps are easily and/or automatically controlled. In some embodiments, the molecular diagnostic test device 1000 can be configured for long term storage in a manner that poses a limited likelihood of misuse (spoilage of the reagent(s), expiration of the reagents(s), leakage of the reagent(s), or the like). In some embodiments, the molecular diagnostic test device 1000 is configured to be stored for up to about 36 months, up to about 32 months, up to about 26 months, up to about 24 months, up to about 20 months, up to about 18 months, up to 12 months, up to 6 months, or any values there between.

The test device 1000 includes a housing 1001 and a sample preparation module 1200 disposed within the housing 1001. The sample preparation module 1200 includes a flexible heater 1230, a carrier 1233, and a base 1210 having a wall 1220 that defines a sample reservoir 1211. The flexible heater 1230 has a first end coupled to an electronics connector 1231 to be in electrical communication with a power source 1905. The carrier 1233 is coupled to and supports the flexible heater 1230 such that a second end of the flexible heater 1230 is disposed with the sample reservoir 1211 spaced apart from the wall 1220. For example, in some embodiments, the carrier 1233 includes a coupling portion and a tab (not shown). The coupling portion couples the carrier to the base 1210, and the tab is coupled to the second end of the flexible heater 1230 to support the flexible heater 1230 spaced apart from the wall 1220 of the base 1210. In some embodiments, the flexible heater 1230 defines an opening through which a portion of the tab of the carrier 1233 extends through. In some embodiments, the base 1210 defines an opening and a portion of the coupling portion of the carrier 1233 is received through the opening of the base to couple the carrier 1233 to the base 1210. Such an embodiment is described below with reference to test device 3000.

Although not shown in FIG. 1, in some embodiments, the test device 1000 can include any other components or modules described herein, such as, for example, a reaction module, an amplification module, a detection module, a reagent module that contains on-board reagents (e.g., the reagent module 3700), a valve (e.g., to control flow of reagents and/or sample, such as the valve 3300), or a fluid transfer module (e.g., the fluid drive module 3400). The test device 1000 can include the same or similar components and function the same or similar as the test devices described in International Patent Publication No. WO2023/018896, entitled, “Molecular Diagnostic Devices and Methods for Retaining and Mixing Reagents,” the disclosure of which is incorporated herein by reference in its entirety.

The housing 1001 can be any structure within which the sample preparation module 1200 or other components are contained (or partially contained) to form an integrated device for sample preparation and/or molecular testing. The housing 1001 can be a monolithically constructed housing or can include multiple separately constructed members that are later joined together to form the housing 1001 or be contained therein.

The housing 1001 can further define an input opening (not shown) through which a biological sample can be conveyed into the sample preparation module 1200 (and more particularly, into the sample reservoir 1211). The housing 1001 can also define a viewing area (not shown) for seeing a visual display of test results or operation. The viewing area can include an opening through an external wall of the housing 1001. In some embodiments, the viewing area can include a window or clear material through which test results can be viewed. The viewing area can include any suitable features to enhance viewing. For example, in some embodiments, the viewing area includes a beveled edge that surrounds (or partially surrounds) the opening. In some embodiments, the housing includes a mask portion (e.g., having contrasting colors or features) that surrounds at least a portion of the opening. The mask portion can be configured to enhance visibility of a detection surface through the viewing area or detection opening.

The sample preparation module 1200 is configured to manipulate a biological sample for further diagnostic testing. For example, in some embodiments, the sample preparation module 1200 can extract target molecules (e.g., nucleic acid) from the biological sample and can produce an input solution that is conveyed into a reaction module (not shown in FIG. 1). Referring to FIG. 1, the sample reservoir 1211 can receive a biological sample that can be conveyed into the test device 1000 by a sample transfer device (not shown in FIG. 1). The sample transfer device can be any suitable device, such as a pipette or other mechanism configured can be used to aspirate or withdraw the sample from a sample cup, container or the like, and then deliver a desired amount of the sample via the input opening of the housing 1001. After the sample is loaded via the input opening, a lid (not shown in FIG. 1—see lid 3070 described below) can be closed. The sample preparation module 1200 can include any components as described herein to manipulate the biological sample for further diagnostic testing and/or to produce a solution for detection of a target molecule (e.g., nucleic acid). For example, in some embodiments, the sample preparation module 1200 can include one or more heaters, one or more chambers within which the biological sample can be manipulated, one or more mixing reservoirs, and/or certain on-board reagents (e.g., a lysing buffer, an RT enzyme, a control substance, or the like). In some embodiments, the sample preparation module 1200 can contain the desired amplification reagents to facilitate a desired amplification according to any of the methods described herein. In other embodiments, the sample preparation module 1200 is configured to extract nucleic acid molecules from the biological sample and can produce an input solution that is conveyed into a reaction module (not shown).

The sample preparation module 1200 can include any components as described herein to manipulate the biological sample for further diagnostic testing and/or to produce a solution for detection of a target molecule (e.g., nucleic acid). The sample reservoir 1211 is a volume within which the biological sample can be mixed with reagents and also heated. As described above, in this embodiment, the sample preparation module 1200 includes a flexible heater 1230 that is partially disposed within the sample reservoir 1211 and used to heat a mixture of the biological sample and the reagents. For example, in some embodiments the biological sample can be collected in the sample reservoir 1211 and mixed with either or both of a control organism (e.g., a first reagent) and a reverse transcriptase (e.g., a second reagent). The control organism and the reverse transcriptase can each be lyophilized or otherwise in solid form. In some embodiments, the solid reagents include a lyophilized pellet. The lyophilized pellet(s) can include one or more of a reducing agent, positive control organism, reverse transcriptase enzymes, or salts. Moreover, the reagents can be secured within the sample reservoir 1211, as described herein, to prevent the reagents from inadvertently falling out of the device 1000, for example during storage, transportation, or use.

In some embodiments, the flexible heater 1230 includes a flexible circuit and a plastic sheath covering the flexible circuit. The flexible heater 1230 (also referred to as “heater”) is positioned within the sample reservoir 1211 such that the heater 1230 is immersed in the biological sample but does not contact the wall 1220 of the base 1210 of the sample reservoir 1211. More specifically, as shown in FIG. 1, the carrier 1233 is coupled to the base 1210 and positioned to support the heater 1230 spaced from the wall 1220. Providing a heater directly within the sample provides for more direct and efficient heating of the sample. In other words, the effects of having a secondary component between a heater and the sample is eliminated, thereby allowing for a more accurate measure of the actual temperature. By immersing the heater directly in the sample, almost all of the energy delivered to the heating element is transferred to the sample, and the temperature of the sample more closely matches the temperature of the heating element. The heater 1230 can be, for example, one or more flexible printed circuit boards (e.g., flex PCBs) manufactured on a polymer substrate. In some embodiments, the substrate on the heater 1230 is a Kapton® substrate. Kapton® is known to be stable at high temperatures and is chemically inert and thus, will not negatively react with the sample or mixture of the reagents.

In some embodiments, the sample preparation module 1200 also includes an input retention lid (not shown in FIG. 1) that is coupled to the base 1210 and disposed partially within the sample reservoir 1211. The carrier 1233 can be coupled to the input retention lid such that a portion of the heater 1230 is disposed between the input retention lid and the wall 1220. Such an embodiment is described below with reference to molecular diagnostic test device 3000. In some embodiments, the input retention lid has a side wall that defines an opening and the carrier 1233 includes a tab, a portion of which is received through the opening of the input retention lid to support and couple the flexible heater 1230 to the base 1210.

Various methods for controlling the flexible heater 1230 are described herein. The temperature accuracy of the flexible heater 1230 that is required to support various diagnostic assays necessitates the use of a closed loop feedback control of the heater 1230. Closed loop control requires a way to measure the signal of interest, which in this case is the surface temperature of the heater 1230. However, a temperature-sensing component assembled onto the surface of the heater 1230 would incur additional manufacturing costs or risk chemically reacting with the patient sample. Thus, the heater 1230 used in the sample preparation module 1200 does not include or use any temperature sensors. The sample reservoir 1211 is also devoid of any temperature sensors.

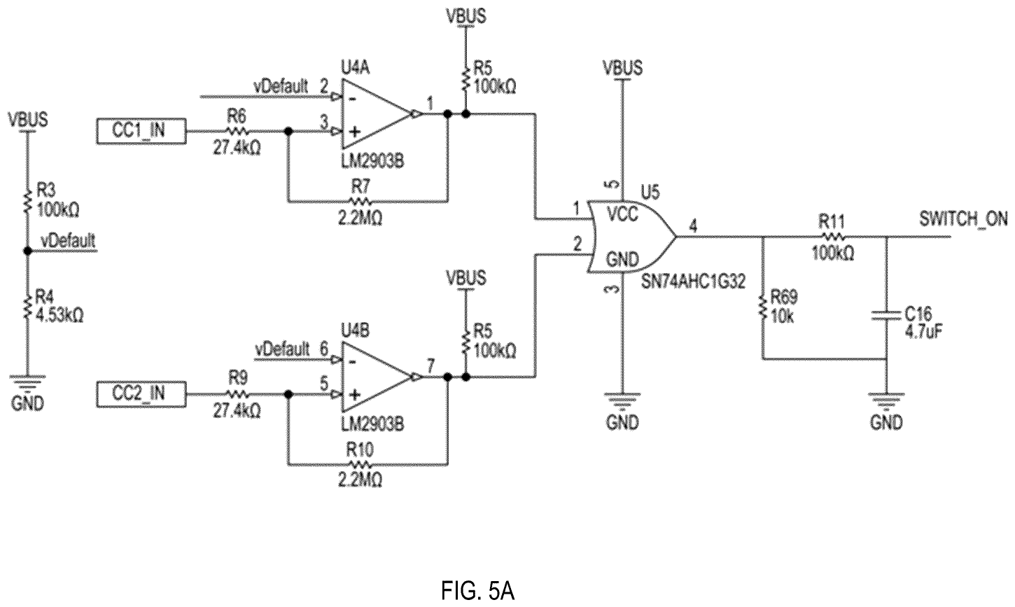

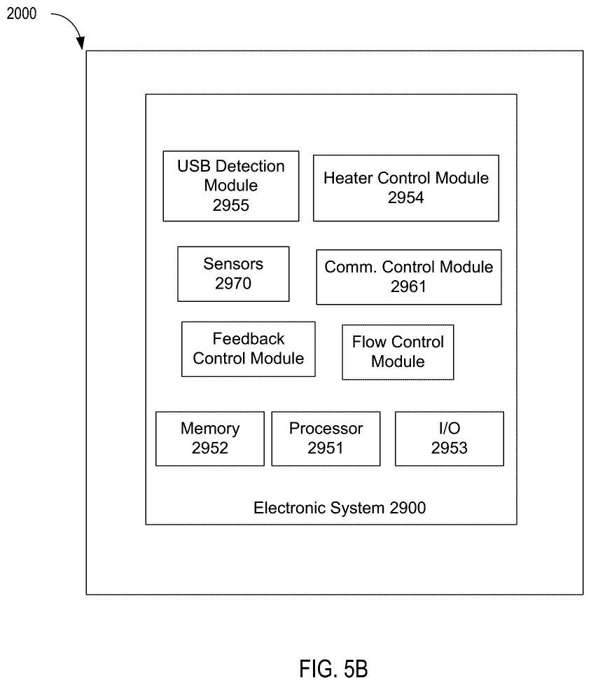

The methods of measuring the sample temperature and controlling the flexible heater 1230 (and any of the flexible heaters described herein) can be executed by any suitable electronic control system. For example, FIG. 5B is a schematic illustration of a molecular diagnostic test device 2000, showing various hardware and software modules of an overall electronic control system 2900. The molecular diagnostic test device 2000 can include any of the components and functions as described herein for other embodiments of a molecular diagnostic test devices and can be a stand-alone device as described herein for other embodiments. For example, the molecular diagnostic test device 2000 can include a detection module, an amplification module, an amplification module printed circuit board heater, a detection module heater and/or any other components described herein. Similarly, the electronic control system 2900 can be included in any of the molecular diagnostic test devices described herein.

The molecular diagnostic test device 2000 includes or is attached to the electronic control system 2900. In some embodiments, the electronic control system 2900 can be coupled to and/or within a housing of the molecular diagnostic test device 2000, and can include one or more printed circuit boards, processors, and/or subsystems. More specifically, the electronic control system 2900 includes any components shown and described in FIG. 5B. The electronic control system 2900 includes at least one processor 2951, at least one memory 2952, one or more sensors (collectively identified as 2970), an input/output subsystem 2953, a communication module 2961, a heater control module 2954 and a USB power cord connection detection module 2955. The electronic control system 2900 can also include other modules for controlling the device (e.g., a flow control module, and a feedback module). Although shown as including each of these application modules, in other embodiments, an electronic control system need not include all (or any) of these modules and can include any other modules described herein.

The processor 2951, and any of the processors described herein can be any suitable processor for performing the methods described herein. In some embodiments, processor 2951 can be configured to run and/or execute application modules, processes and/or functions associated with the molecular diagnostic test device 2000. For example, the processor 2951 can be configured to run and/or execute the communication module 2961, and/or any of the other modules described herein, and perform the methods associated therewith. The processor 2951 can be, for example, a Field Programmable Gate Array (FPGA), an Application Specific Integrated Circuit (ASIC), a Digital Signal Processor (DSP), and/or the like. The processor 2951 can be configured to retrieve data from and/or write data to memory, e.g., the memory 2952. In some embodiments, the processor 2951 can be a microprocessor.

The memory 2952 can be, for example, random access memory (RAM), memory buffers, hard drives, databases, erasable programmable read only memory (EPROMs), electrically erasable programmable read only memory (EEPROMs), read only memory (ROM), flash memory, hard disks, floppy disks, cloud storage, and/or so forth. In some embodiments, the memory 2952 stores instructions to cause the processor 2951 to execute modules, processes and/or functions associated with the molecular diagnostic test device 2000. For example, the memory 2952 can store instructions to cause the processor 2951 to execute any of the application modules described herein, and perform the methods associated therewith.

The sensor(s) 2970 included within the electronic control system 2900 can include any number of switches, optical/light input sensors, temperature sensors, contact sensors, and/or any other suitable input device. The sensor(s) 2970 can include any of the sensors described herein.

The input/output subsystem 2953 (which functions as a user interface) can include any suitable components for conveying information to, and in some embodiments, receiving information from, a user. For example, in some embodiments, the input/output subsystem 2953 can include one or more light output devices (e.g., LEDs) that produce a light signal that can be easily seen by the user to read the device. For example, in some embodiments, the input/output subsystem 2953 can include a red LED that emits red light from an opening in the device housing when an invalid test has occurred (e.g., when no signal is detected from a control detection surface). The input/output subsystem 2953 can also include a green LED that emits green light from an opening in the device housing when a signal from the control detection surface has been detected, indicating that a valid test has occurred.

In some embodiments, the input/output subsystem 2953 can include LEDs that are aligned with one of the control windows or control openings defined by the housing. For example, the input/output subsystem 2953 can include LEDs aligned with openings corresponding to one of the conditions to be detected by the test device. In other embodiments, the input/output subsystem 2953 can produce any suitable electronic output to be read by the user. Such electronic outputs can include an audible output (e.g., produced by a speaker), a haptic (vibratory) output, a light output (e.g., as described herein), and a wireless signal.

In some embodiments, the input/output subsystem 2953 can include a monitor or screen that displays visual elements to a user. The screen can be a touch screen upon which a series of graphical user interface elements (e.g., windows, icons, input prompts, graphical buttons, data displays, notification, or the like) can be displayed. In some embodiments, the graphical user interface elements (not shown) are produced by a user interface module. In such embodiments, the user can also enter information into the electronic system 2900 via the input/output subsystem 2953.

The communication module 2961 can be a hardware and/or software module (stored in memory 2952 and/or executed in the processor 2951). The communication module 2961 is configured to receive an indication (e.g., from the sensor(s)) and/or test result information from the digital detection module and transmit an output signal associated with the test result. The output signal(s) are produced to the user via the input/output subsystem 2953, as described above.

The heater control module 2954 can be a hardware and/or software module (stored in memory 2952 and/or executed in the processor 2951) and can be used to control one or more of the heaters included in the molecular diagnostic test device. For example, the heater control module 2954 can be used to control the flexible heaters 1230 described above and 3230 described below. As described below, in some embodiments, the processor 2951 can be configured to measure a resistance change of the flexible heater (e.g., 1230) to approximate a change in temperature within the sample reservoir (e.g., 1211). The processor can also be configured to adjust a current supplied to the flexible heater based on the approximated change in temperature.

The USB power connection detection module 2955 can be a hardware and/or software module (stored in memory 2952 and/or executed in the processor 2951) and can be used to implement and control the detection system described below for detecting when a USB connector has been connected to the molecular diagnostic test device 2000 and when to make power from the connector available to the test device 2000.

In some embodiments, a method of controlling the heater 1230 uses a property of electrically conductive materials called the temperature coefficient of resistance (temperature coefficient). The temperature coefficient relates a change in a material's temperature to a change in that material's ability to conduct electrical current (resistance). The metal used within the heating element in the flexible heater 1230 is, for example, copper which has a temperature coefficient of approximately 0.4% per degree Celsius; meaning for every 1° C. change in the flexible heater 1230 temperature, the resistance of the flexible heater 1230 increases 0.4%. By detecting the change in resistance, either by a direct measurement or inferred from another measurement, the relative temperature change of the heater 1230, and by extension the fluid, is determinable. By referencing information about the flex PCB resistance such as a calibration curve or the resistance measured at a known temperature, the test device 1000 can approximate the absolute temperature with sufficient accuracy for processing the biological sample.

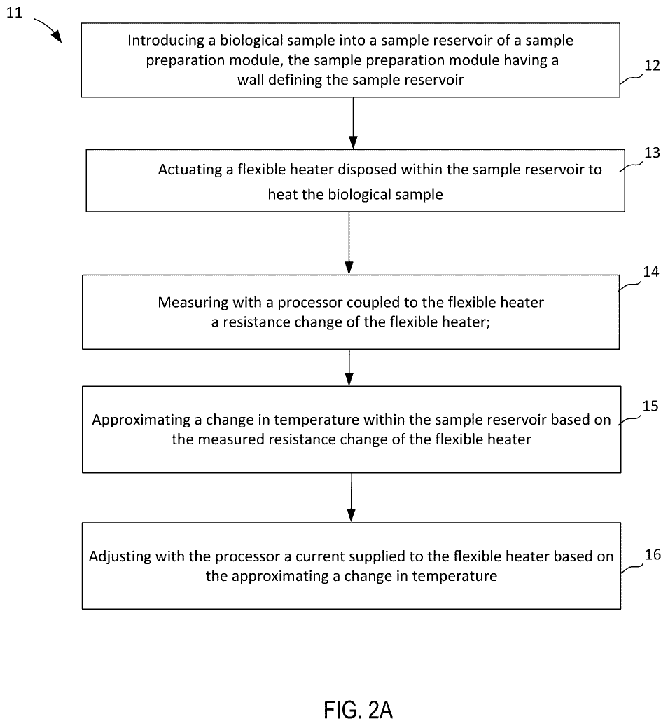

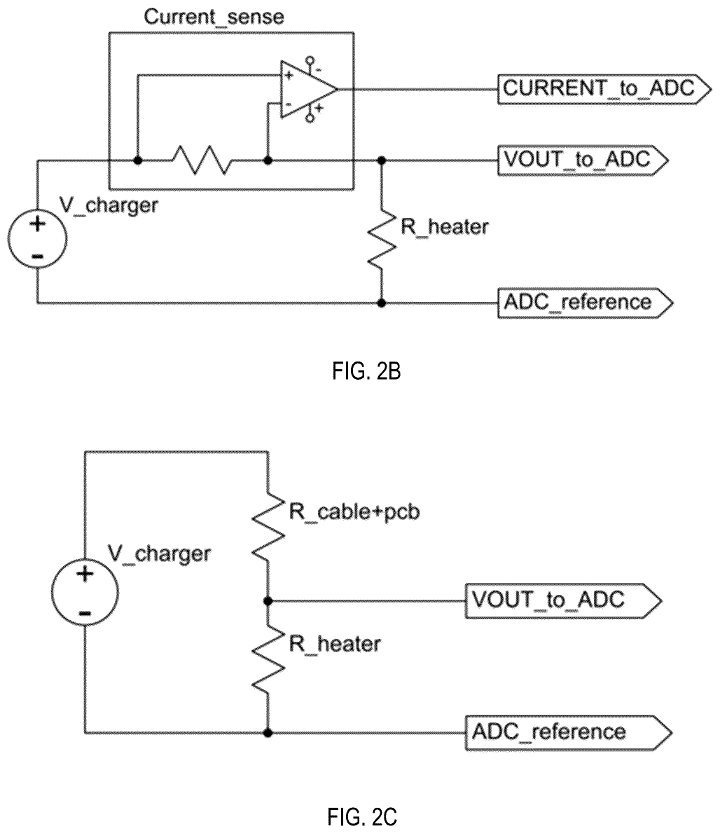

FIG. 2A is a flowchart illustrating a method 11 of detecting a change in heater resistance of a flexible heater (e.g., the flexible heater 1230 and flexible heater 3230 described below). The method is described with reference to test device 1000 but should be understood that the same method can be performed using any of the test devices described herein. The method of FIG. 2A uses a direct measurement of resistance. As shown in the electronics schematic of FIG. 2B, the resistance (R) can be calculated as voltage (V) divided by current (I), (R=V/I) (Ohm's Law). The test device 1000 described above can include a microcontroller (e.g., processor 2951) coupled to or included in a heater control module (e.g., 2954) that incorporates an analog to digital converter (ADC) that measures voltages at various locations within the flexible heater 1230. Using a current-sensing amplifier circuit that outputs a voltage signal proportional to the current through the heater 1230, the microcontroller measures the voltage V across the heater 1230, and the current I through the heater 1230. With these two values, the microcontroller executes a computation of Ohm's Law to determine the instantaneous resistance R of the heater. The microcontroller measures the resistance R when the test sequence begins and stores the result as the starting resistance of the heater 1230. To control the heater 1230, the microcontroller compares subsequent resistance measurements to the starting resistance and calculates the temperature change using the temperature coefficient of the copper within the heater 1230. Absolute temperature may be determined by comparing the starting resistance and/or the slope of the change in resistance to a calibration value(s) stored in the microcontroller memory.

When the test device 1000 is first powered up, the test device 1000 can measure the ambient temperature by averaging the temperatures of any other heaters of the device. While being manufactured, the test device 1000 can read the temperature of the controlled manufacturing environment and probe the flex PCB (e.g., heater 1230) resistance to store a characteristic value of the resistance at a controlled temperature. The test device 1000 can then power on the flexible heater 1230 for a brief period to measure a starting current and starting voltage, and then calculate a starting resistance. The test device 1000 can compare the starting resistance to the known characteristic value and determine a temperature of the flex heater 1230 and therefore the biological sample in which the heater is disposed. The device can periodically measure the current to the flexible heater 1230 and the voltage of the flexible heater 1230 and use the measured current and voltage to calculate the resistance change. Once the resistance reaches a value predicted by the desired temperature change, power to the flexible heater 1230 is kept constant to maintain the temperature.

As shown in FIG. 2A, the method 11 is a method of controlling the temperature within a sample preparation module 1200 of a molecular diagnostic device using a heater 1230 and method as generally described above. Although described as being performed with the device 1000 in other embodiments, the method 11 can be performed using any suitable device, such as the device 3000 described herein. The method 11 includes at 12, introducing a biological sample into a sample reservoir 1211 of a sample preparation module (e.g., 1200). The sample preparation module 1200 includes a wall (e.g., 1220) defining a sample reservoir (e.g., 1211). At 13, a flexible heater (e.g., heater 1230) disposed within the sample reservoir is actuated to heat the biological sample. At 14, a processor (e.g., 2951) coupled to the flexible heater (e.g., 1230) measures a resistance change of the flexible heater. At 15 a change in temperature within the sample reservoir is approximated based on the measured resistance change of the flexible heater. At 16, the processor adjust a current supplied to the flexible heater based on the approximated change in temperature.

In some embodiments, measuring a resistance change of the flexible heater is performed during a first time period, and the resistance change is a first resistance change and the change in temperature is a first change in temperature. In such embodiments, the processor measures during a second time period after the first time period, a second resistance change of the flexible heater. The second change in temperature within the sample reservoir is then approximated based on the measured second resistance change of the flexible heater. In some embodiments, the current supplied to the flexible heater is adjusted at a first adjustment time, and the processor, at a second adjustment time, adjust a current supplied to the flexible heater based on the approximation of the second change in temperature.

In some embodiments, the second resistance change is compared to a preset temperature change value, and if the second resistance change is equal to the preset temperature change value, a constant current is supplied to the flexible heater to maintain a temperature of the flexible heater constant.

In some embodiments, after actuating the flexible heater, a resistance change of the flexible heater is measured by measuring a first current and a first voltage of the flexible heater. Based on the first current and the first voltage, a first resistance of the flexible heater is calculated and the first resistance is compared to a stored resistance value to determine the resistance change of the flexible heater.

Another method for detecting a change in heater resistance includes measurement of the voltage across the heater. This alternative method of detecting a change in heater resistance is described with reference to test device 1000 but should be understood that the same method can be performed using any of the test devices described herein. This alternative method exploits the non-zero resistance of the power cable (coupled to the test device 1000) and the main controller PCB for the test device 1000. A circuit known as a “resistive voltage divider” connects two resistors in a series configuration and takes its output as the voltage across the second resistor. The voltage across the second resistor Vout is proportional to a percentage contribution of the second resistor to the total series resistance.

$$Vout ∝ R 2 / ( R 1 + R 2 )$$

As shown in the electronics schematic of FIG. 2C, the cable and PCB resistance form the first resistor of the divider and the heater acts as the second heater. Because the cable and PCB resistances are stable relative to the heater temperature, they are assumed constant. As the heater resistance increases, its percentage contribution to the total series resistance also increases, so the voltage across it increases. The microcontroller can track this voltage change over time and correlate it to the change in heater temperature.

As described above for the method 11, in this method when the test device 1000 is first powered up, the test device 1000 can measure the ambient temperature by averaging the temperatures of any other heaters of the device. While being manufactured, the test device 1000 can read the temperature of the controlled manufacturing environment and probe the flex PCB (e.g., heater 1230) resistance to store a characteristic value of the resistance at a controlled temperature. The test device 1000 measures the voltage supplied by the charger connected to the test device 1000. The test device 1000 then powers on the flexible heater 1230 for a brief period to measure the voltage of the flexible heater 1230. The test device 1000 turns on power to the flexible heater 1230 to heat the biological sample and periodically measures the voltage of the flexible heater 1230 to calculate the temperature change. Once the voltage reaches a value predicted by the desired temperature change, power to the flexible heater 1230 is kept constant to maintain the temperature.

The test devices described herein (e.g., 1000, 2000, 3000, 4000, 5000) can also include a controller board for detecting when a USB connector is connected to the test device. For example, in some embodiments, the controller board can be included in (or operably coupled to) the USB detection module 2955 shown in FIG. 5B. Devices and methods for detecting when a USB connector is connected to a test device are described below with reference to test device 1000 but should be understood that the same methods can be performed using any of the test devices described herein.

In some embodiments, the test device 1000 is configured to use USB Type-C chargers as an input power source. USB Type-C connectors support delivering up to 100 Watts (W) of power from a charger to a device per the USB Implementers Forum's (USB-IF) USB Type-C Cable and Connector Specification. This specification details the functions of a USB Type-C port's Configuration Channel (CC) pins. For the test device 1000, a resistor is connected between the CC pin and the ground reference of the system for each of the USB Type-C CC pins. As described below, the test device 1000 can detect when a USB Type-C power source is connected to the test device, determine the power capability of the power source, and provide bidirectional communication between the test device and the power source.

At the default USB voltage of 5 Volts (V), a device may draw up to 3 Amps (A) for a total of 15 W without communicating with the power source. The test device 1000 identifies the power capability of the source by measuring the voltage across the CC pin resistor. After detecting that a USB cable has been attached to the test device, the device waits a minimum period before turning on and drawing power from the USB connector.

The test device 1000 is configured to detect when a power cable (e.g., USB connector power input) is connected to the test device without the use of specialized components, which reduces component costs. Instead, the test device 1000 and associated methods utilizes two comparators, a logical OR gate, an R-C time delay network, an electronic load switch, and the analog to digital converter (ADC) integrated in the application microcontroller. An example electrical schematic of this configuration is shown in FIG. 5A.

In some embodiments, the components and method of detecting a connection of a USB power input to the test device and determining a power capability of the USB power source includes taking as an input at a comparator integrated circuit (IC) two voltage measurements: the voltage of a CC pin associated with the USB connector and a fixed reference voltage. A second comparator IC of the test device monitors the second CC pin associated with the USB connector and the same reference voltage. The reference voltage is derived from the nominal 5 V signal provided by the USB charger.

A logical OR gate receives as its inputs the output voltages of the two comparators. When the voltage on a CC pin exceeds the threshold of the reference voltage, that comparator outputs a signal. Only one CC pin can exceed the threshold at any time per the USB Type-C specification. When one of the logical OR gate inputs detects the signal, the OR gate output increases from 0 V to 5 V. The output of the logical OR gate drives a resistor and capacitor that form an R-C time delay network. The values of the resistor and capacitor are selected so that the rise time of the network meets a turn-on delay specified in the USB Type-C Cable and Connector Specification. When the output voltage of the R-C network is sufficiently high, the electronic load switch is enabled and power becomes available to the rest of the device. The microcontroller of the test device uses its ADC pins to measure the voltage on each CC pin associated with the USB connector to determine the power available to the test device. If the source does not indicate that up to 15 W is available, the test device signals to the user that the charger is insufficient to run the PCR test sequence of the test device.

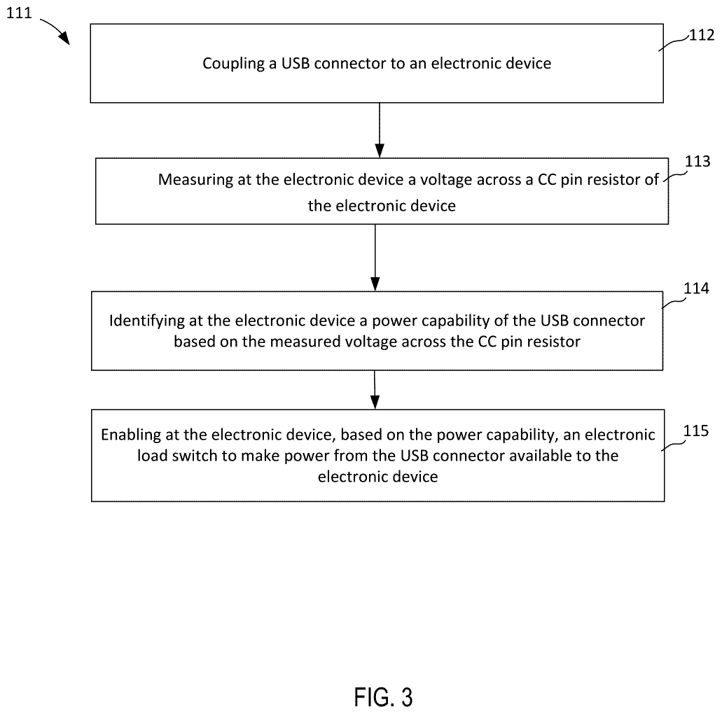

FIG. 3 is a flowchart illustrating a method 111 of detecting a connection of a USB connector to an electronic device, such as a molecular diagnostic test device described herein, without the use of dedicated integrated circuits, according to an embodiment. The method 111 includes at 112, coupling a USB connector to an electronic device (e.g., test device 1000, 3000). At 113, the electronic device measures a voltage across a CC pin resistor of the electronic device. At 114, the electronic device identifies a power capability of the USB connector based on the measured voltage across the CC pin resistor. At 115, based on the power capability of the USB connector, the electronic device enables an electronic load switch to make power from the USB connector available to the electronic device.

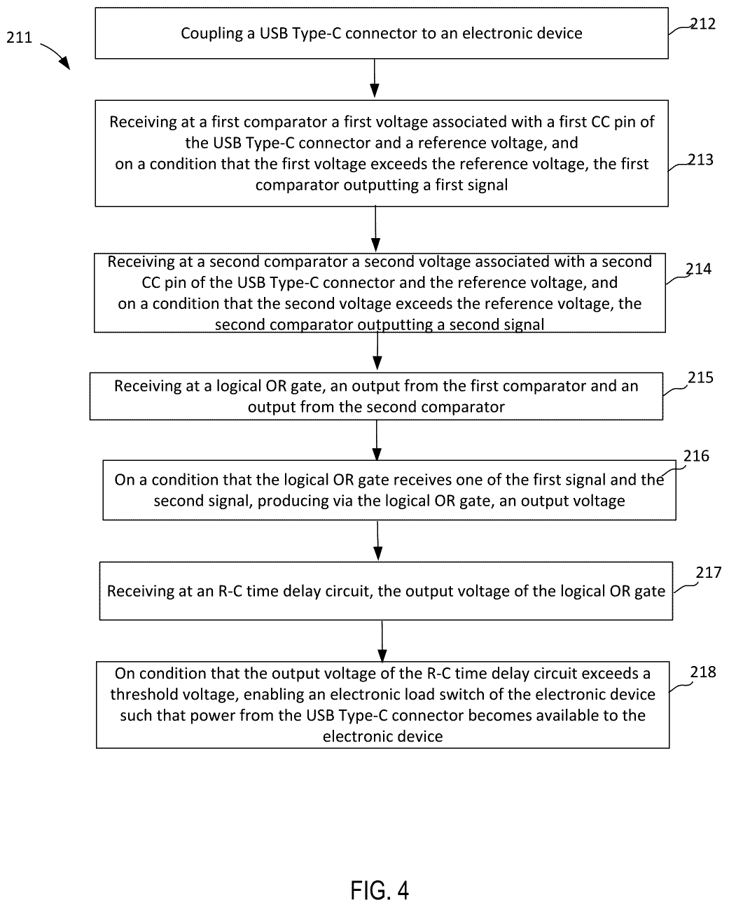

FIG. 4 is a flowchart illustrating a method 211 of detecting the connection of a USB Type-C connector to an electronic device, such as a molecular diagnostic test device described herein, without the use of dedicated integrated circuits, according to another embodiment. The method 211 includes at 212, coupling a USB connector to an electronic device (e.g., test device 1000, 3000). At 213, a first voltage of a first CC pin associated with the USB Type-C connector and a reference voltage are received at a first comparator of the electronic device. If the first voltage exceeds the reference voltage, the first comparator outputs a first signal. At 214, a second voltage associated with a second CC pin of the USB Type-C connector and the reference voltage are received at a second comparator of the electronic device. If the second voltage exceeds the reference voltage, the second comparator outputs a second signal. At 215, an output from the first comparator and an output from the second comparator are reeved at a logical OR gate. At 216, if the logical OR gate receives one of the first signal and the second signal, the logical OR gate produces an output voltage. In some embodiments, if the logical OR gate receives one of the first signal and the second signal, the logical OR gate increases the output voltage from 0 volts to 5 volts.

At 217, the output voltage of the logical OR gate is received at an R-C time delay circuit. At 218, if the output voltage received at the R-C time delay circuit exceeds a threshold voltage, an electronic load switch of the electronic device is enabled such that power from the USB Type-C connector becomes available to the electronic device.

In some embodiments, the first voltage and the second voltage are measured at an analog to digital converter (ADC) pin. At the ADC pin, a power of the USB Type-C connector available to the electronic device is determined based on the first voltage and the second voltage. If the power is determined to be less than 15 Watts, a signal is output indicating that the power is insufficient.

In some embodiments, power sources may be limited to provide only 3 Amps (A) to the test devices described herein. Accordingly, it is desirable not to draw more than 3 A of current to minimize the risks of triggering an auto-shutdown protection algorithm of the power source (e.g., charger) or of damaging the charger. To minimize the likelihood that the device may cause the device to exceed a current threshold, in some embodiments, the heaters (e.g., heater 1230, 3230 etc.) of the test devices described herein can be controlled with a pulse width modulated (PWM) signal that either applies or removes power to the heating element. For example, such a PWM can be part of the heater control module (e.g., 2954) of the test device. Temperature regulation is achieved by varying the portion of time that the element receives power (e.g., duty cycle); a higher duty cycle delivers more power to the heater and raises the heater temperature. Because a heating element draws its maximum current while it receives a pulse of power, the peak current draw of the test device is determined by the number of heaters that are simultaneously receiving pulses of power. In some embodiments, a desired solution can maximize the current any given heater can draw and minimize the number of heaters that receive power simultaneously.

There are two parameters of the heater control signals that determine how many heaters are on simultaneously: the maximum duty cycle and the phase of the signal relative to other heater signals. If heater control signals are permitted to reach a 100% duty cycle, those heaters can always be on. Turning on two or more heaters thus creates the possibility of multiple heaters drawing current simultaneously. If two or more heater control signals are in phase, then the energizing pulse of the PWM signal for those heaters occurs at the same time regardless of each heater's duty cycle. This process guarantees that multiple heaters draw current simultaneously.

In some embodiments, any of the devices described herein can include firmware that both limits the maximum duty cycle of the heaters and keeps sets of heaters out of phase. The firmware manages this by grouping heaters whose simultaneous current draw does not exceed 3 A and disabling all but one group. Each heater group is permitted to draw current for a fixed period. When the service time elapses, the firmware disables that heater group and allows the next group to draw current. This has the effect of limiting the maximum duty cycle of all heaters in a group to that group's permissible period divided by the total time it takes to service all heaters. The firmware measures the temperature of the heaters and continuously calculates the duty cycle needed to maintain the temperatures. In this way, when a heater is ready for servicing, the correct duty cycle is applied for accurate temperature control.

$$Duty Cycle ( max ) \% = 100 * \frac{service period of group}{time to service all groups}$$

Because only one group of heaters receives power, groups of heaters are effectively out of phase. For example, in the case of two groups that each seek to operate at 100% duty cycle, and if the firmware allows each group to receive power for an equal period, the resulting effective duty cycle of the groups would be 50%. Because the groups' energizing pulses never occur at the same time, the PWM signals are out of phase.

Further, selection of the heater grouping depends on the physical heater element. The heaters are conductive copper traces embedded in the printed circuit board of the test device. These traces are designed to have a high enough resistance to dissipate enough power as heat to perform PCR. By designing the resistance of the elements to draw less than 1.5 A, at least two heaters can turn on in the same group. However, increasing the resistance of a heater decreases the power it can dissipate as heat and may cause the heater to fail to reach its final temperature. The resistances of the heater elements are thus configured to exploit the fact that the resistance of copper increases as temperature increases. At nominal room temperature, the heater resistance is low enough to draw enough current to reach its final temperature. This may exceed 1.5 A. As the heater's temperature increases, its peak current draw decreases due to the increased resistance. This peak current then drops below 1.5 A, so the heater can turn on with at least one other heater without exceeding the 3 A limit. By offsetting when each heater turns on, multiple heaters with a room temperature current draw greater than 1.5 A can share the same service period.

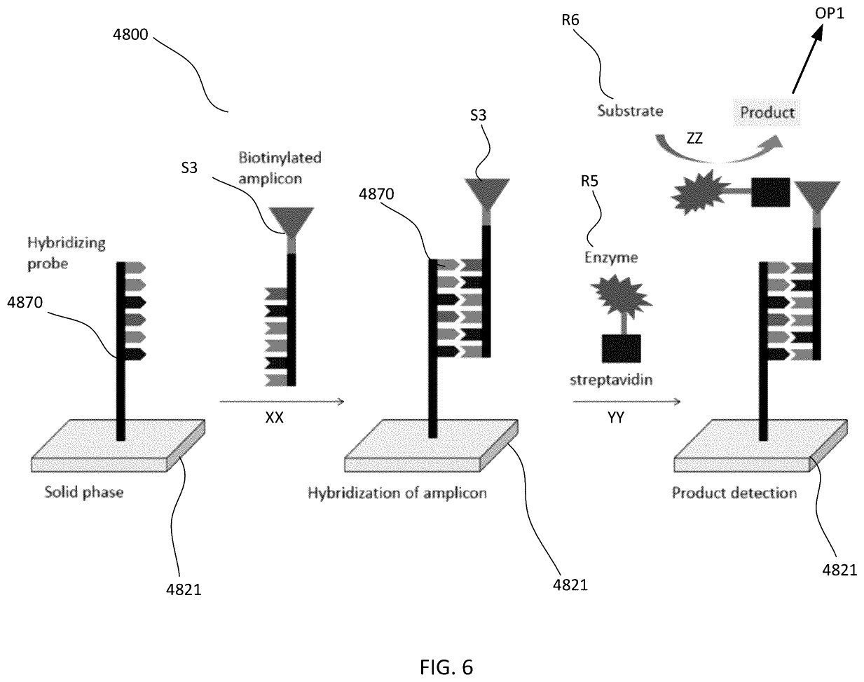

FIG. 6 illustrates a portion of the operations and/or features associated with an enzymatic reaction, according to an embodiment, that can be conducted by or within any of the test devices (1000, 2000, 3000, 4000, 5000) and more particularly in any reaction modules (e.g., reaction module 3600) and any detection modules described herein (e.g., the detection module 3800 described below). In some embodiments, the enzymatic reaction can be carried out to facilitate visual detection of a molecular diagnostic test result using the test device 1000, 2000, 3000, 4000, 5000, or any other devices or systems described herein. In other embodiments, the enzymatic reaction need not be performed to produce visual detection. For example, as described herein, in some embodiments, the methods that employ the illustrated enzymatic reaction can employ alternative methods to read a result associated with signal produced.

In some embodiments, the devices (including any of the various devices shown and described herein) can be configured for use in a decentralized test facility. Further, in some embodiments, the reaction shown in FIG. 6 can facilitate the devices (including any of the various devices shown and described herein) operating with sufficient simplicity and accuracy to be a CLIA-waived device. Similarly stated, in some embodiments, the reaction shown in FIG. 6 can provide the output signal OP1 in a manner that poses a limited likelihood of misuse and/or that poses a limited risk of harm if used improperly. In some embodiments, the reaction can be successfully completed within the device (or any other device described herein) upon actuation by a user with minimal (or no) scientific training, in accordance with methods that require little judgment of the user, and/or in which certain operational steps are easily and/or automatically controlled.

In some embodiments, the detection module 4800 is included as a part of the reaction module (e.g., 3600). In other embodiments, the reaction modules function without a specific detection module but include a detection surface 4821 within a read lane or flow channel. In embodiments having a detection module 4800 (which can also include test device 3000), the detection module 4800 includes a detection surface 4821 within a read lane or flow channel. The detection surface 4821 is spotted and/or covalently bonded with a specific hybridizing probe 4870, such as an oligonucleotide. The hybridizing probe 4870 (also referred to as a capture probe) can be similar to any of the capture probes described herein. In some embodiments, the hybridizing probe 4870 is specific for a target organism, nucleic acid, and/or amplicon. The bonding of the hybridizing probe 4870 to the detection surface 4821 can be performed using any suitable procedure or mechanism. For example, in some embodiments, the hybridizing probe 4870 can be covalently bound to the detection surface 4821.

Reference S3 illustrates the biotinylated amplicon that is produced from the amplification step such as, for example, by an amplification module (or any other amplification modules or processes described herein such as those operating within a reaction module such as 3600). The biotin can be incorporated within the amplification operation and/or within the amplification module in any suitable manner. As shown by the arrow XX, the output from the amplification module, including the biotinylated amplicon S3 is conveyed within the read lane and across the detection surface 4821. The hybridizing probe 4870 is formulated to hybridize to the target amplicon S3 that is present within the flow channel and/or in proximity to the detection surface 4821. The detection module 4800 and/or the detection surface 4821 is heated to incubate the biotinylated amplicon S3 in the read lane in the presence of the hybridizing probe 4870 for a few minutes allowing binding to occur. In this manner, the target amplicon S3 is captured and/or is affixed to the detection surface 4821, as shown. Although disclosed as being labeled with biotin, in other embodiments, the target molecules can be labeled in any suitable manner that will allow binding of the complex comprising a sample molecule binding moiety and an enzyme capable of facilitating a colorimetric reaction. For example, in some embodiments, the target molecules can be labeled with one or more of the following: streptavidin, fluorescein, Texas Red, digoxigenin, or Fucose.

In some embodiments, a first wash solution (not shown in FIG. 6) can be conveyed across the detection surface 4821 and/or within the flow channel to remove unbound PCR products and/or any remaining solution. Such wash solution can be, for example, a multi-purpose reagent, and the first reagent R1. In other embodiments, however, no wash operation is conducted.

As shown by the arrow YY, a detection reagent R5 is conveyed within the read lane and across the detection surface 4821. The detection reagent R5 can be any of the detection reagents described herein. In some embodiments, the detection reagent R5 can be a horseradish peroxidase (HRP) enzyme (“enzyme”) with a streptavidin linker. In some embodiments, the streptavidin and the HRP are cross-linked to provide dual functionality. As shown, the detection reagent is bound to the captured amplicon S3. The detection module 4800 and/or the detection surface 4821 is heated to incubate the detection reagent R5 within the read lane in the presence of the biotinylated amplicon S3 for a few minutes to facilitate binding.

In some embodiments, a second wash solution (not shown in FIG. 6) can be conveyed across the detection surface 4821 and/or within the flow channel to remove unbound detection reagent R5. Such wash solution can be, for example, a multi-purpose reagent, as described with reference to the first reagent R1. In other embodiments, however, no second wash operation is conducted.

As shown by the arrow ZZ, a detection reagent R6 is conveyed within the read lane and across the detection surface 4821. The detection reagent R6 can be any of the detection reagents described herein. The detection reagent R6 can be, for example, a substrate formulated to enhance, catalyze and/or promote the production of the signal OP1 when reacted with the detection reagent R5. Specifically, the substrate is formulated such that upon contact with the detection reagent R5 (the HRP/streptavidin) color molecules are produced. As such, a colorimetric output signal OP1 is developed where HRP attaches to the amplicon. The color of the output signal OP1 indicates the presence of bound amplicon: if the target pathogen, target amplicon and/or target organism is present, the color product is formed, and if the target pathogen, target amplicon and/or target organism is not present, the color product does not form.

In some embodiments the detection reagent R6 can be continuously flowed across the detection surface 4821 to ensure that the reaction producing the color molecules does not become limited by the availability of the detection reagent. Moreover, in some embodiments, the detection reagent R6 can be a precipitating substrate.

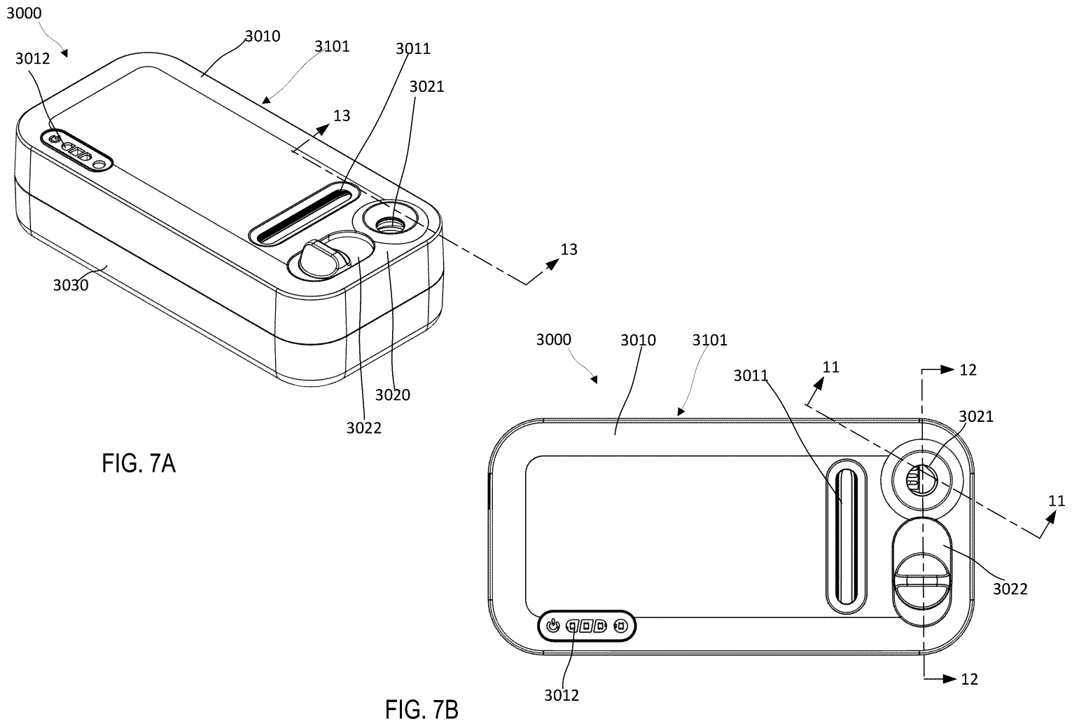

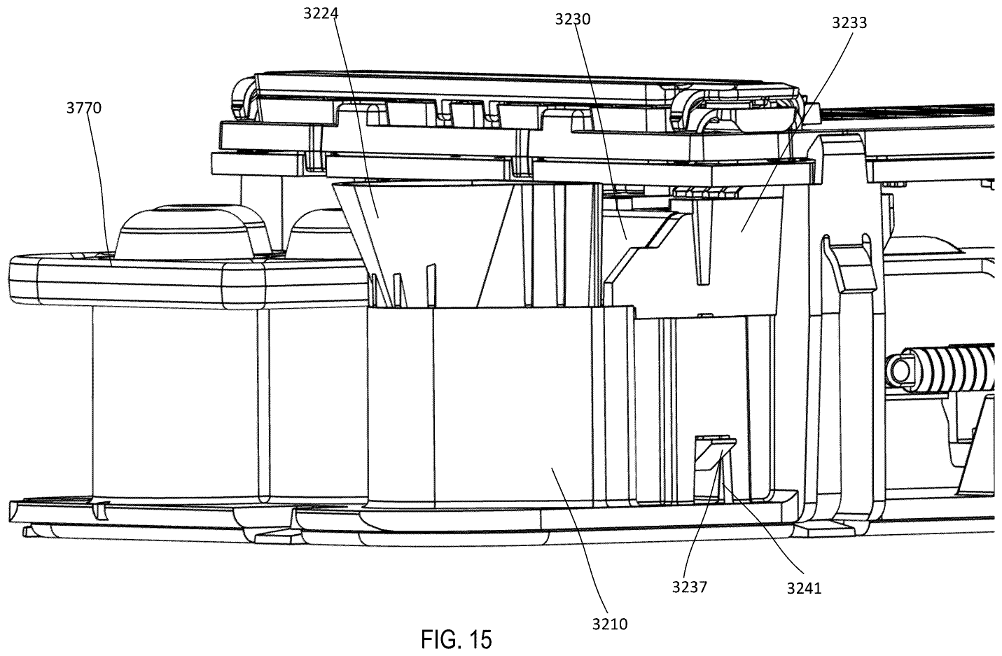

FIGS. 7A-20C illustrate a test device 3000 according to an embodiment. The test device 3000 is an integrated device (i.e., the modules are contained within a single housing) that is suitable for use within a point-of-care setting (e.g., doctor's office, pharmacy or the like), decentralized test facility (e.g., work sites or public venues), or at the user's home. In some embodiments, the test device 3000 can have a size, shape and/or weight such that the test device 3000 can be carried, held, used and/or manipulated in a user's hands (i.e., it can be a “handheld” device). A handheld device may have dimensions less than 15 cm×15 cm×15 cm, or less than 15 cm×15 cm×10 cm, or less than 12 cm×12 cm×6 cm. In other embodiments, the test device 3000 can be a self-contained, single-use device. Similarly stated, the test device 3000 is a stand-alone device that includes all necessary substances, mechanisms, and subassemblies to perform any of the molecular diagnostic tests described herein. As such, the test device 3000 does not require any external instrument to manipulate the biological samples, and only requires a connection to a power source (e.g., a connection to an A/C power source, coupling to a battery, a USB charger, or the like) to complete the methods described herein. In some embodiments, the test device 3000 can be configured with lock-outs or other mechanisms to prevent re-use or attempts to re-use the device.

Further, in some embodiments, the test device 3000 can be a CLIA-waived device and/or can operate in accordance with methods that are CLIA waived. Similarly stated, in some embodiments, the test device 3000 (and any of the other devices shown and described herein) is configured to be operated in a sufficiently simple manner and can produce results with sufficient accuracy to pose a limited likelihood of misuse and/or to pose a limited risk of harm if used improperly. In some embodiments, the test device 3000 (and any of the other test devices shown and described herein), can be operated by a user with minimal (or no) scientific training, in accordance with methods that require little judgment of the user, and/or in which certain operational steps are easily and/or automatically controlled. In some embodiments, the molecular diagnostic test device 3000 can be configured for long term storage in a manner that poses a limited likelihood of misuse (spoilage of the reagent(s), expiration of the reagents(s), leakage of the reagent(s), or the like). In some embodiments, the molecular diagnostic test device 3000 is configured to be stored for up to about 36 months, up to about 32 months, up to about 26 months, up to about 24 months, up to about 18 months, up to about 6 months, or any values there between.

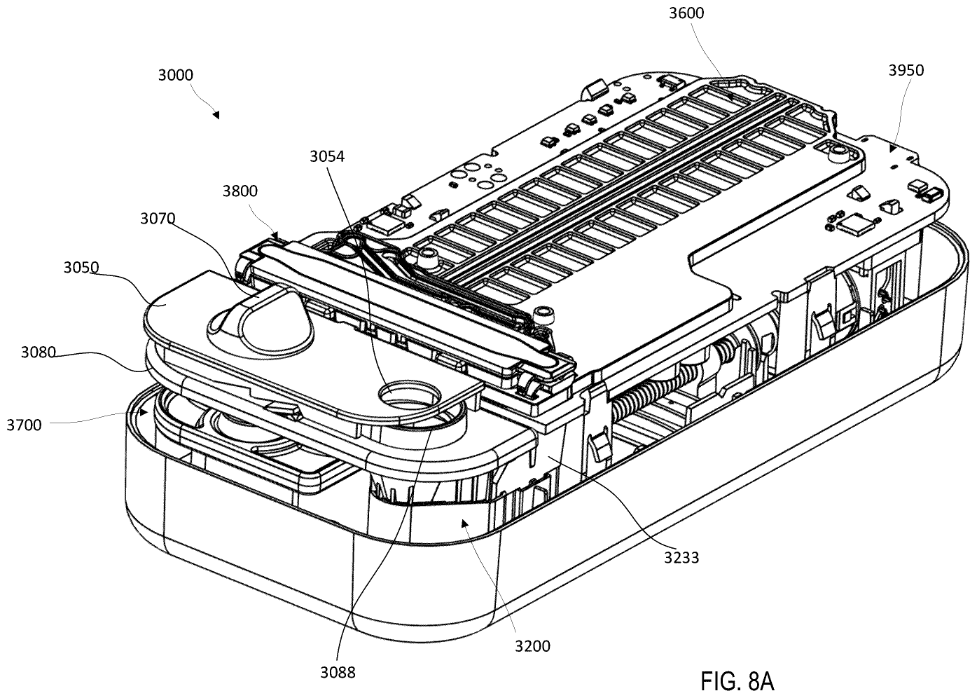

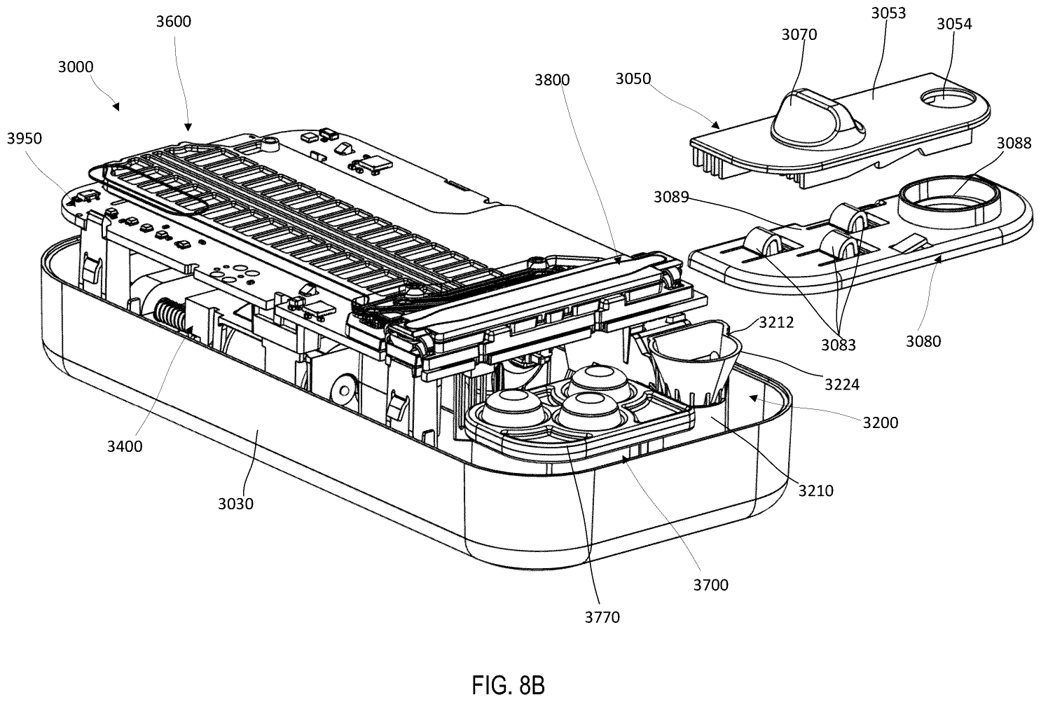

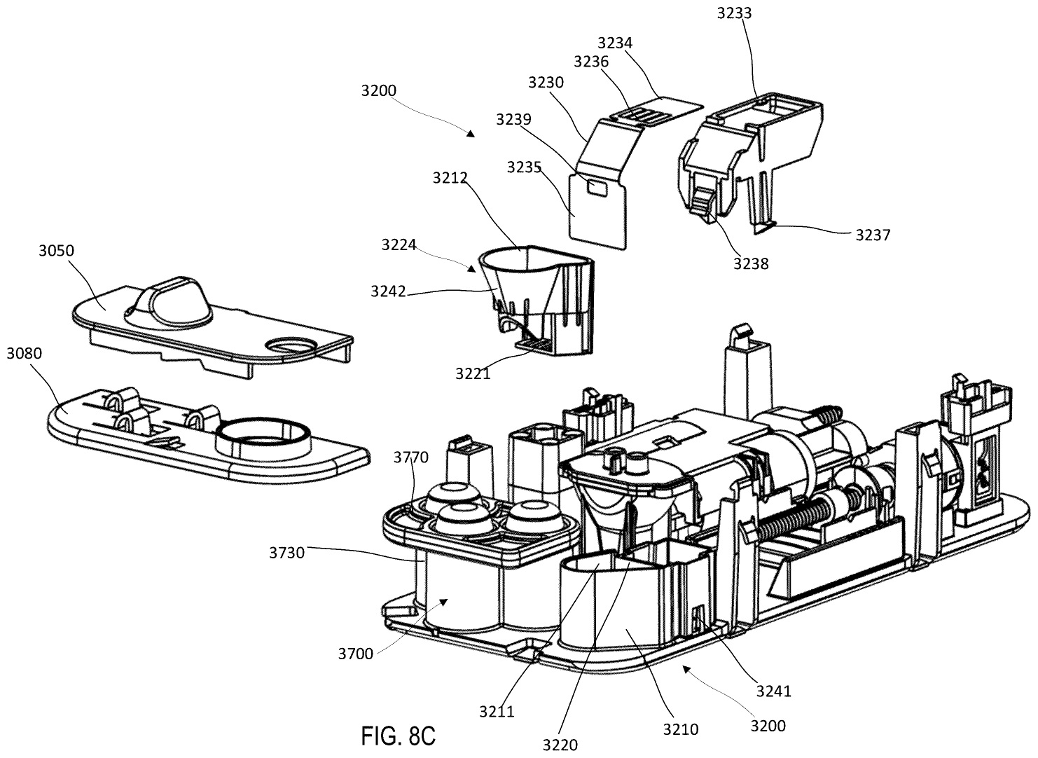

FIGS. 7A-20C show various views of the molecular diagnostic test device 3000 (also referred to as “test device”). The test device 3000 is configured to manipulate an input solution to produce one or more output signals associated with a target cell, according to any of the methods described herein. The diagnostic test device 3000 includes a housing 3001 (including a top housing or portion 3010 and a bottom housing or portion 3030), within which the modules and components described herein are fully or partially contained. Similarly stated, the housing 3001 (including the top housing 3010 and/or the bottom housing 3030) at least partially surround and/or enclose the modules and components of the test device 3000. As shown, for example, in FIGS. 8A-10, the test device 3000 includes a sample preparation module 3200, a fluidic drive (or fluid transfer) module 3400, an amplification module 3600, a detection module 3800, a reagent module 3700, the fluid transfer valve (not shown), and an electronic control module 3950 positioned within the housing 3001. A description of the housing assembly 3001 is followed by a description of each module and/or subsystem.

The housing assembly 3001 includes the top housing 3010, the bottom housing 3030, and a lid 3050 (which functions as a cover and an actuator). As shown, the top housing 3010 defines a detection opening 3011 (also referred to as a detection window or viewing area), a series of status light openings 3012 and a sample input portion 3020. The status light openings 3012 are aligned with one or more light output devices (e.g., LEDs) of the electronic control module 3950. In this manner, a light output produced by such status lights is visible through the status light openings 3012. Such light outputs can indicate, for example, whether the test device 3000 is receiving power from the power source, whether an error has occurred (e.g., an error associated with insufficient sample volume or the like), and whether the test has been successfully completed.

The detection opening (or window) 3011 is aligned with the detection module 3800. In this manner, the signal produced by and/or on each detection surface of the detection module 3800 is visible through the detection opening 3011. In some embodiments, the top housing 3010 is opaque (or semi-opaque), thereby “framing” or accentuating the detection opening. In some embodiments, for example, the top housing 3010 can include markings (e.g., thick lines, colors or the like) to highlight the detection opening 3011. For example, in some embodiments, the top housing 3010 can include indicia identifying the detection opening to a specific disease (e.g., SARS-COV-2, Chlamydia trachomatis (CT), Neisseria gonorrhea (NG) and Trichomonas vaginalis (TV)) or control. Moreover, as described in International Patent Publication No. WO2023/018896, entitled “Molecular Diagnostic Devices and Methods for Retaining and Mixing Reagents” (the disclosure of which is incorporated herein by reference in its entirety), the detection module 3800 is biased against the top housing 3010 to minimize the distance between the detection module 3800 and the detection opening 3011. This biased arrangement minimizes shadows and optical aberrations and improves readability of the test results. In other embodiments, the top housing 3010 need not include a detection opening 3011. For example, in such embodiments, the signal produced by the detection module 3800 is not visible to the naked eye, but instead is read using another method. For example, in some embodiments, the reading can include using a secondary device, such a mobile computing device to scan or otherwise receive the signal OP1. In yet other embodiments, the reading the result can include indirectly reading a secondary signal that conveys the results associated with (or describing) the primary output from the detection module 3800.

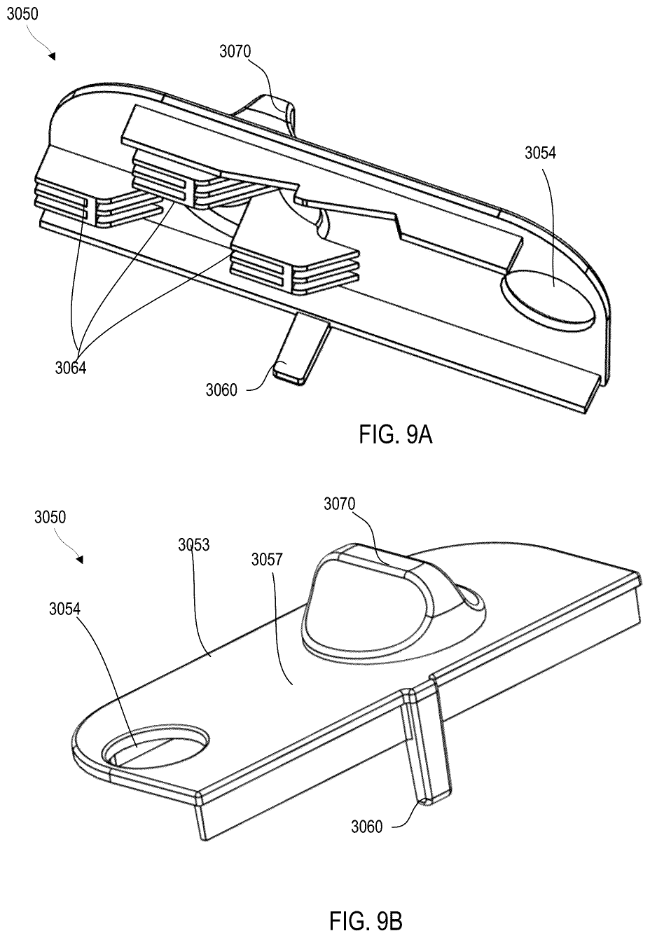

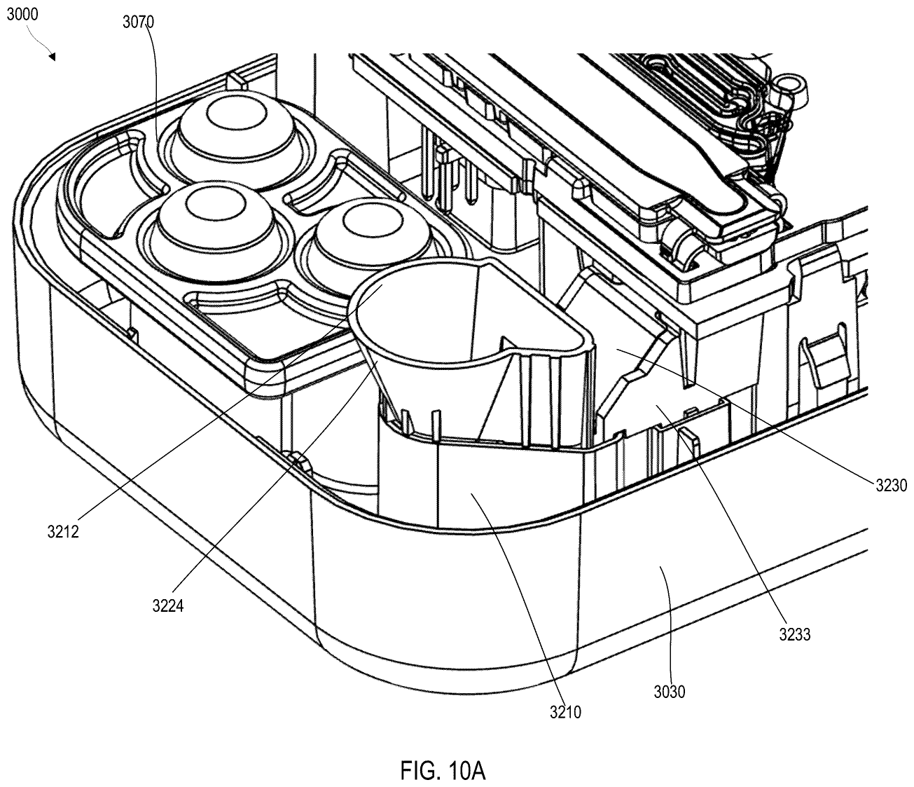

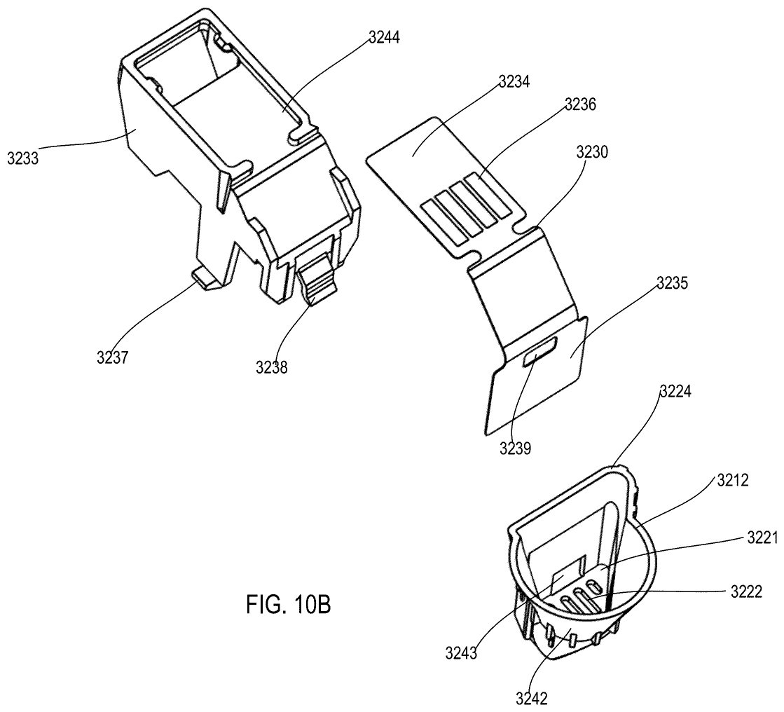

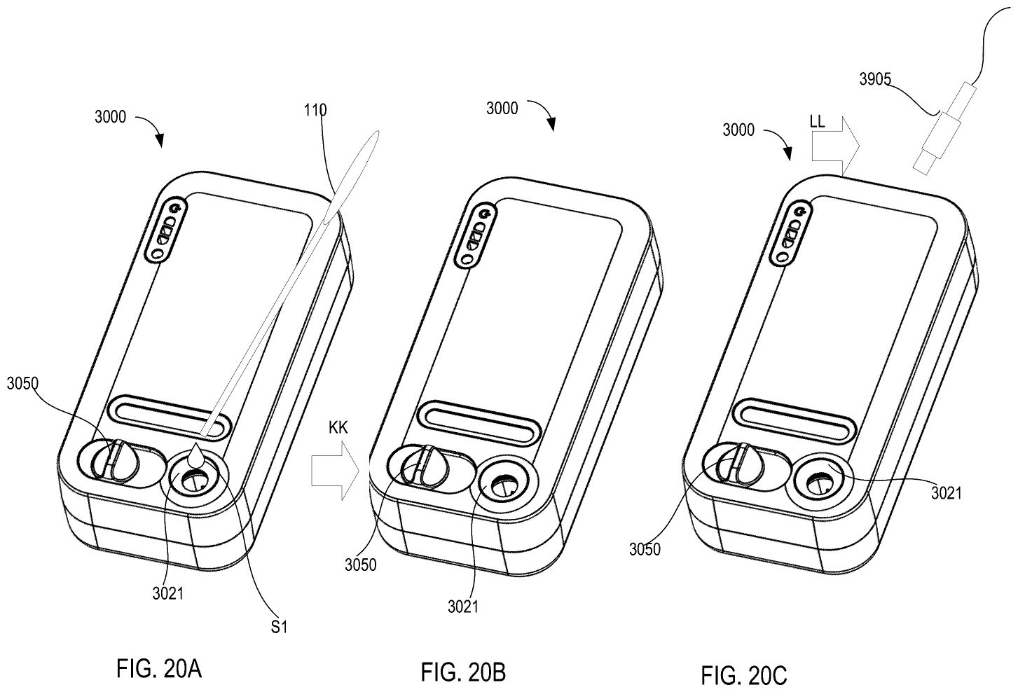

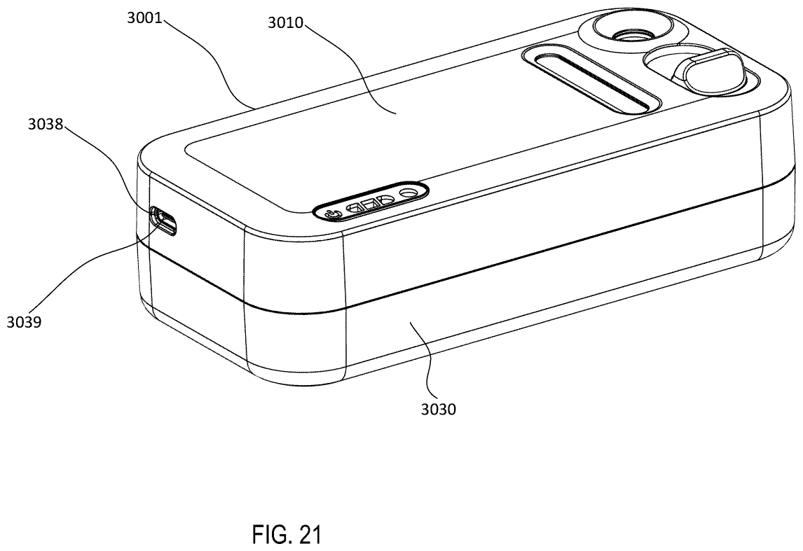

The sample input portion 3020 defines a sample input opening 3021 (also referred to as a housing input opening) and an actuator opening 3022. The sample input opening 3021 is aligned with an input opening 3212 (see, e.g., FIGS. 9 and 10) of the sample preparation module 3200 and provides an opening through which a biological sample can be conveyed into the test device 3000. Additionally, the sample input portion 3020 also allows the lid (or actuator) 3050 to be movably coupled to the top housing 3010. Specifically, the lid 3050 is coupled to the top housing 3010 such that a handle 3070 of the lid 3050 extends through the actuator opening 3022. The actuator opening 3022 is elongated to allow for sliding movement of the lid 3050 relative to the top housing 3010, as described herein. As shown in FIG. 21, the top housing 3010 defines an opening 3038 that is aligned with a power input port 3039 of the electronic control module 3950. In use, an end of a power cord (e.g., a USB connector of a power input cord) can be coupled to the electronic control module 3950 via the opening 3038 (see e.g., the coupling of the power cord 3905 in FIG. 20C).

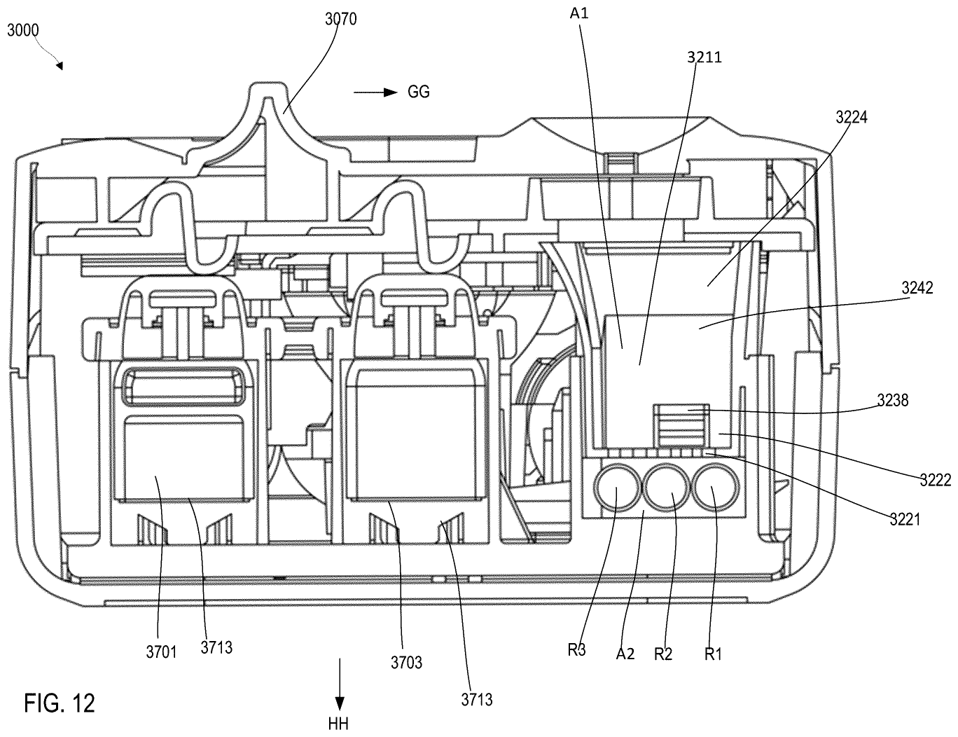

As shown in FIGS. 8A, 8B and 9, the lid 3050 is coupled to the housing 3001 and is positioned between the top housing 3010 and a flexible plate 3080. The lid 3050 and the flexible plate 3080 collectively actuate the reagent module 3700 when the lid 3050 is moved relative to the housing 3001. More specifically, guide rails of the lid 3050 are configured to engage with the flexible plate 3080, and thus also facilitate sliding movement of the lid 3050 (relative to the flexible plate 3080). As shown by the arrow GG in FIG. 12, the lid 3050 is configured to move relative to the housing 3001 from a first (or opened) position to a second (or closed) position. The lid and actuation of the test device 3000 can be the same as or similar to the lid and actuation of the devices described in PCT International Application No. WO2023/018896 incorporated by reference above.

The lid 3050 is configured to perform a variety of functions when moved relative to the housing 3001, thereby facilitating actuation of the test device 3000 via a single action. Specifically, as shown in FIGS. 9A and 9B, the lid 3050 includes a cover portion 3053, a switch portion 3060, and three reagent actuators 3064. The cover portion 3053 defines an input opening 3054. When the lid 3050 is in the opened position, the input opening 3054 is aligned with each of the sample input opening 3021 of the top housing 3010, the input opening 3088 of the flexible plate 3080, and the input opening 3212 of the sample preparation module 3200 and thus provides an opening through which the biological sample S1 can be conveyed into the test device 3000.

In addition to covering the input opening 3212, closing the lid 3050 also actuates other mechanisms within the test device 3000. For example, the switch portion 3060 of the lid 3050 includes a protrusion that actuates a switch (not shown) when the lid 3050 is moved from the opened position to the closed position. Specifically, the switch portion 3060 indirectly actuates the switch by deforming a corresponding switch portion 3089 of the flexible plate 3080. When the lid 3050 is moved to the closed position, the switch portion 3060 slides within the gap that separates the corresponding switch portion 3089 from the body of the flexible plate 3080, thereby deforming the corresponding switch portion 3089 into an outward position. When in its outward position, the corresponding switch portion 3089 actuates one or more switches (not shown). For example, when a switch is actuated (i.e., is moved from a first state to a second state), power from the power source (e.g., the power source 3905) can be provided to the electronic control module 3950 and any other components within the test device 3000 that require power for operation. For example, in some embodiments, power is provided to any of the heaters (e.g., a heater 3230 of the sample preparation module 3200 (described below), a heater of the amplification module 3600, and a heater of the detection module 3800) directly or via the electronic control module 3950. For example, this allows the heater 3230 to begin preheating for a lysis operation after the lid 3050 is closed and the device 3050 is coupled to the power source 3905 without requiring further user action. The switch (and the corresponding switch portion 3060) can be any suitable switch that performs the functions described herein. For example, in some embodiments, the switch can be an isolation member that electrically isolates the power source 3905 from the remaining components of the electronic control module 3950. In such embodiments, the switch portion 3060 can be coupled to, and can remove, the isolation member (thereby electrically coupling the power source 3905 to the electronic control module 3950). In other embodiments, the switch portion 3060 is the isolation member, and no separate switch is included in the electronic control module 3950.

As shown in FIGS. 9A and 9B, the reagent actuators 3064 include a series of ramped surfaces that exert an actuation force on a corresponding set of deformable actuators 3083 of the flexible plate 3080 when the lid 3050 is moved from the opened position to the closed position. In this manner, the reagent actuators 3064 (and the deformable actuators 3083 of the flexible plate 3080) cause the reagent to be released from the sealed reagent containers within the reagent module 3700, as described in more detail below.

The flexible plate 3080 The three deformable actuators 3083 of the flexible plate 3080 are each aligned with a corresponding reagent actuator 3064 of the lid 3050 and one of three reagent containers (two of which are identified as 3701 and 3703 in FIG. 12). Thus, when the lid 3050 is moved relative to the housing 3001, the reagent actuators 3064 and the deformable actuators 3083 actuate the reagent module 3700. In particular, as described in detail below, the reagent actuators 3064 and the deformable actuators 3083 move the reagent containers within a reagent manifold 3730 to release the reagents that are sealed within the containers.

The reagent module 3700 includes the reagent manifold (or housing) 3730, three reagent containers, and a deformable support member 3770. The reagent module 3700 provides mechanisms for long-term storage of reagents within the sealed reagent containers, actuation of the reagent containers to release the reagents from the reagent containers for use during the methods described herein. In addition to providing storage and actuating functions, the reagent module 3700 also provides fluid interconnections to allow the reagents and/or other fluids to be conveyed within the test device 3000. Specifically, as described herein, the reagent module 3700 is fluidically coupled to the fluid transfer valve (not shown) in a manner that allows selective venting, fluid coupling, and/or conveyance of the reagents and substances within the test device 3000.

The reagent module 3700 can store packaged reagents such as, for example, a dual-purpose blocking and wash solution, an enzyme reagent, and a substrate, and allows for easy un-packaging and use of these reagents in the detection module 3800. As shown, for example, in FIG. 12, the reagent module 3700 has a first reagent container 3701, a second reagent container (not shown) and a third reagent container 3703. Each reagent container includes a connector at a first end portion and a frangible seal at a second, opposite end portion. The connectors connect the reagent containers (e.g., 3701, 3703) to a mating coupling portion of the deformable support member 3770. The frangible seal can be any suitable seal, such as, for example, a heat-sealed BOPP film (or any other suitable thermoplastic film). Such films have excellent barrier properties, which prevent interaction between the fluids within the reagent container and external humidity, but also have weak structural properties, allowing the films to be easily broken when needed. When the reagent container is pushed into the puncturers, the frangible seal breaks, allowing the liquid reagent to flow into the appropriate reagent reservoir when vented by the fluid transfer valve.

The reagent manifold 3730 includes three reagent tanks within which the reagent containers are disposed. Specifically, the reagent manifold includes a first reagent tank within which the first reagent container 3701 is disposed, a second reagent tank within which the second reagent container 3702 is disposed, and a third reagent tank within which the third reagent container 3703 is disposed. The reagent housing 3730 includes a pair of puncturers in the bottom portion of each reagent tank. The puncturers are configured to pierce the frangible seal of the respective reagent container when the reagent container is moved downward within the reagent housing 3730. Similarly stated, the reagent housing 3730 includes a set of puncturers that pierce a corresponding frangible seal to open a corresponding reagent container when the reagent module 3700 is actuated. The puncturers define a flow path that places the internal volume of the reagent container and/or the reagent tank in fluid communication with an outlet port of the reagent module 3700 after the frangible seal is punctured.

The deformable support member 3770 is configured to deform from a first configuration to a second configuration in response to an actuation force exerted thereon (e.g., by the deformable actuator 3083). Moreover, the deformable support member 3770 is biased in the first (or undeformed) configuration. In this manner, the deformable support member 3770 supports each of the reagent containers in a “storage state” when the deformable support member 3770 is in the first configuration. Similarly stated, the deformable support member 3770 maintains the puncturer spaced apart from the frangible seal 3713 of the reagent container 3701 when the deformable support member is in the first configuration.

When the lid 3050 is moved, the downward force exerted by the deformable actuators 3083 cause the deformable support member 3770 to transition to the second (or deformed) configuration. Similarly stated, when the downward force is sufficient to overcome the opposite, biasing force of the deformable support member 3770, the deformable support member 3770 is transitioned to the second configuration, as shown by the arrow HH in FIG. 12. This causes each of the reagent containers to move downward within the corresponding reagent tank, bringing the puncturers into contact with the frangible seal of each reagent container. Similarly stated, when the deformable support member 3770 is in the second configuration, the puncturers pierce the frangible seal 3713 of the reagent containers. When the reagent module 3700 is actuated, each of the first reagent container 3701, the second reagent container, and the third reagent container 3703 are actuated in this manner. Thus, in addition to covering the sample input opening and providing power to the electronic control module 3950, closing the lid 3050 also actuates all of the reagent containers.

Although shown as including three reagent containers, in other embodiments, the reagent module 3700 (or any of the reagent modules described herein) can have any suitable number of reagent containers. For example, in some embodiments, a reagent module can include only one reagent container or more than three reagent containers.

As described herein, the sample preparation module 3200 can perform any or all of A) receiving the biological sample, B) mixing the biological sample with desired reagents (e.g., a positive control reagent RI and/or a reverse transcriptase R2), C) performing lysing operations to release target RNA from the biological sample S1, D) performing a reverse transcription reaction to produce cDNA, and E) heating the resulting solution to inactivate the reverse transcriptase. Thus, in some embodiments, the sample preparation module enables an efficient, fast RT-PCR to be performed within a single environment or module. By eliminating the need for external sample preparation and a cumbersome instrument, the test device 3000 is suitable for use within a point-of-care setting (e.g., doctor's office, pharmacy or the like), a decentralized location, or at the user's home and can receive any suitable biological sample. The biological sample (and any of the input solution described herein) can be, for example, blood, urine, male urethral specimens, vaginal specimens, cervical swab specimens, and/or nasal swab specimens gathered using a commercially available sample collection kit.

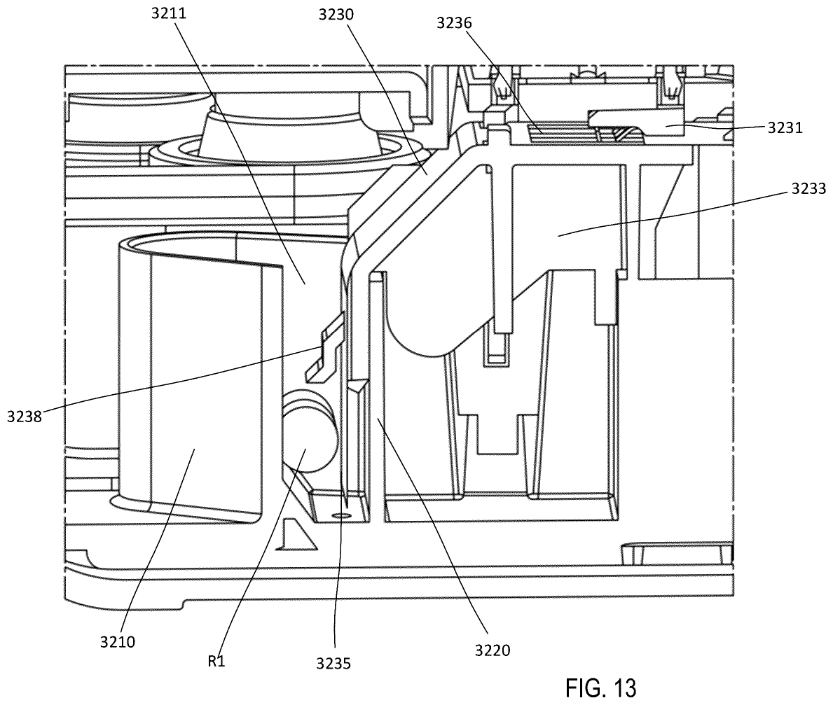

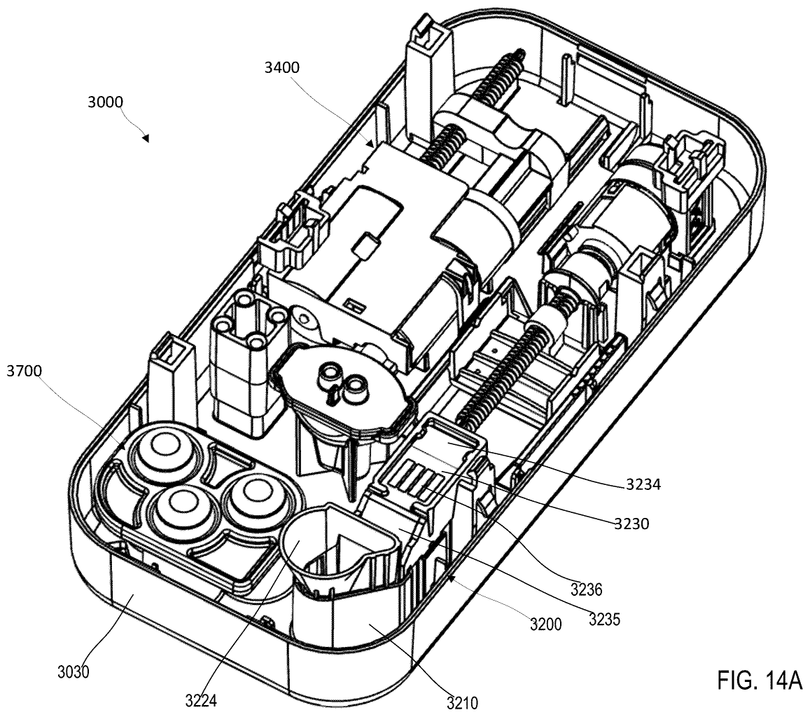

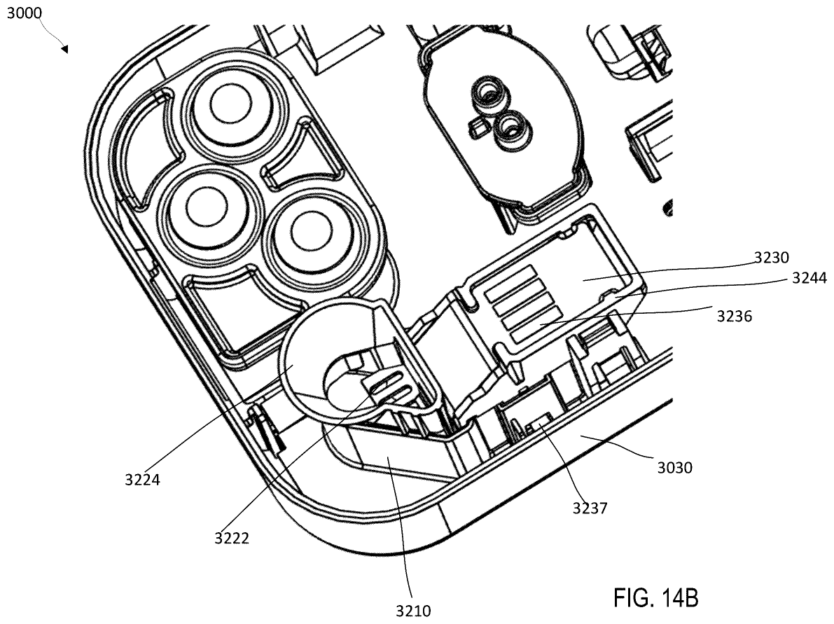

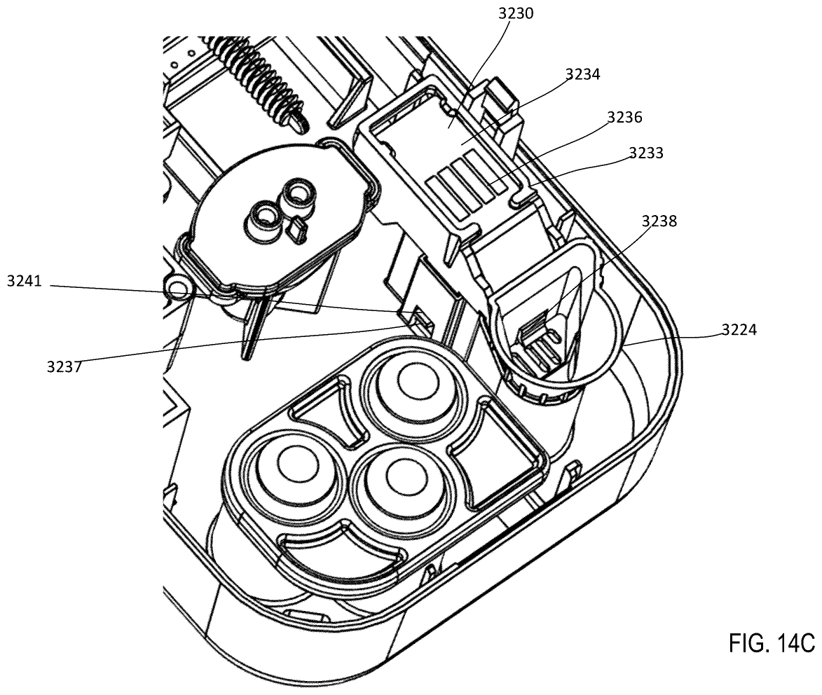

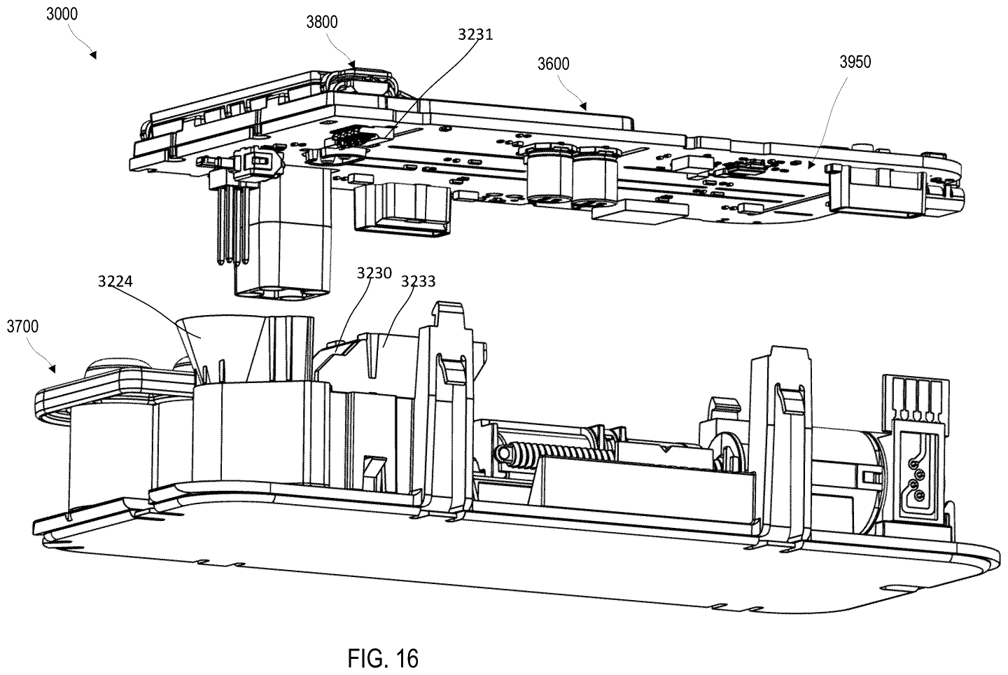

The sample preparation module 3200 is disposed within the housing 3001 and includes a flexible heater 3230, a carrier 3233 and a base 3210. The base 3210 has a wall 3220 that defines a sample reservoir 3211. The base 3210 can also include other support structure portions of the test device 3000. The flexible heater 3230 has a first end portion 3234 and a second end portion 3235. The first end portion 3234 is coupled to an electronics connector 3231 (see FIGS. 13 and 16) to be in electrical communication with a power source 3905 (see FIG. 20C). For example, as shown in FIGS. 10B, 14A-14C, the flexible heater 3230 includes connector pads 3236 on the first end portion 3234 that electrically couple to the electrical connector 3231. The connector pads 3236 can be formed from a conductive material (e.g., copper) and can provide a sufficient surface area for coupling to the electrical connector 3231. The connector pads 3236 form an electrical connection to the heating elements (e.g., conductive traces) within the flexible heater 3230. The second end portion 3235 extends into sample reservoir 3211 and is spaced from the wall 3220 as shown, for example, in FIG. 13.

The carrier 3233 is coupled to the base 3210 and supports the flexible heater 3230 such that the second end portion 3235 is disposed with the sample reservoir 3211 spaced apart from the wall 3220 as described above. The carrier 3233 includes a tab 3238 that extends through an opening 3239 of the flexible heater 3230 to support the second end portion 3235 of the flexible heater 3230 to the base 3210 spaced apart from the wall 3220 (see FIG. 13). The carrier 3233 has a top portion 3244 on which the first end portion 3234 of the heater 3230 is disposed. The carrier 3233 also includes two coupling portions 3237 (see e.g., FIGS. 10B, 15 and 16) that extend through openings 3241 of the base 3210 to couple the carrier 3233 to the base 3210.

In some embodiments, the flexible heater 3230 includes a flexible circuit and a plastic sheath covering the flexible circuit. The sheath can be constructed from an inert material and can reduce the likelihood of any undesirable interaction between the heater 3230 and the biological sample. As described above, the flexible heater 3230 (also referred to as “heater”) is positioned within the sample reservoir 3211 such that the second end portion 3235 of the heater 3230 is immersed in the biological sample but does not contact the wall 3220 of the base 3210 of the sample reservoir 3211. Providing the heater 3230 directly within the sample provides for more direct and efficient heating of the sample. In other words, the effects of having a secondary component between a heater and the sample is eliminated, allowing for rapid heating and a more accurate measure of the actual temperature of the biological sample. By immersing the heater 3230 directly in the sample, almost all of the energy delivered to the heating element is transferred to the sample, and the temperature of the sample more closely matches the temperature of the heating element. The heater 3230 can be, for example, one or more flexible printed circuit boards (e.g., flex PCBs) manufactured on a polymer substrate. In some embodiments, the substrate on the heater 3230 is a Kapton® substrate. Kapton® is known to be stable at high temperatures and is chemically inert and thus, will not negatively react with the sample or mixture of the reagents. The heater can include one or more resistive heating elements that receive current from the power source and produce thermal energy used to controllably heat the biological sample.

Various methods for controlling the flexible heater 3230 are described above and can be employed in test device 3000. For example, the test device 3000 can include any of the components and modules described with reference to FIG. 5B. Further, the test device 3000 can be used to perform the methods described in FIGS. 2A-2C. In some embodiments, the flexible heater 3230 uses a closed loop feedback control of the heater 3230. Closed loop control includes measuring the signal of interest, which in this case is the surface temperature of the heater 3230. However, a temperature-sensing component (e.g., thermocouple or thermistor) assembled onto the surface of the heater 3230 would incur additional manufacturing costs or risk chemically reacting with the biological sample. Thus, the heater 3230 used in the sample preparation module 3200 does not include or use any temperature sensors. The sample reservoir 3211 is also devoid of any temperature sensors.

Instead, the electronic controls of the test device 3000 can use the methods described above for test device 1000 to detect a change in resistance, either by a direct measurement or inferred from another measurement to approximate temperature changes of the heater 3230 and thereby temperature changes in the biological sample. As described previously, by referencing known information about the resistance of the flexible heater 3230 (and specifically, the resistive heating elements therein), such as a calibration curve or the resistance measured at a known temperature, the test device 3000 can approximate the absolute temperature with sufficient accuracy for processing the patient sample. Thus, the test device 3000 uses the methods of detecting a change in heater resistance of the flexible heater 3230 as described above for test device 1000. Based on the change in temperature, the electronic control module 3950 can regulate the current supplied to the heater 3230 to ensure that the temperature of the biological sample is rapidly heated to the desired temperature to perform the reactions described herein (e.g., lysing, reverse transcription). Moreover, the electronic control module 3950 can perform any of the methods described herein to prevent the biological sample from being overheated (e.g., boiled), which can lead to erroneous test results. Finally, the electronic control module 3950 can perform the methods of temperature measure and control described herein, along with the methods of PWM heater control described above, to ensure that the maximum current draw of the device 3000 remains within the desired limits.

The input retention lid 3224 includes an extension portion 3242 that defines the input opening 3212 and a retention screen 3221. The input retention lid 3224 is positioned partially within the sample reservoir 3211 and the extension portion 3242 extends upward outside of the sample reservoir 3211. The tab 3238 of the carrier 3233 extends through the opening 3239 of the heater 3230 and through the opening 3243 of the input retention lid 3224. The input opening 3212 is in communication with the sample reservoir 3211 and with the openings 3088, 3054 and 3021 of the housing 3101 as described above such that a biological sample can be received in the sample reservoir 3211 through the openings.

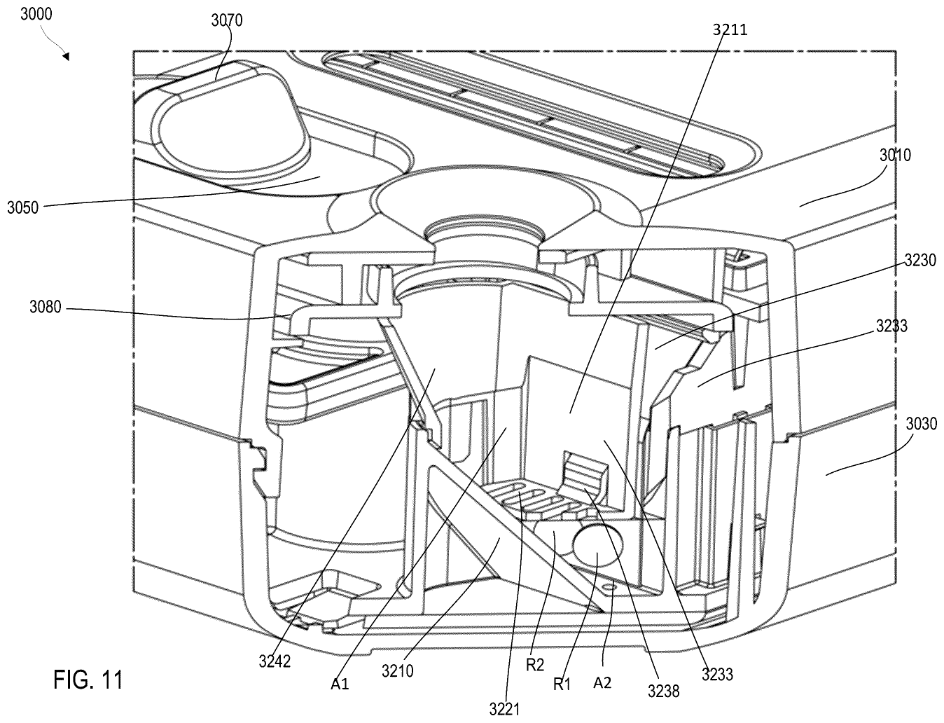

The retention screen 3221 is positioned within the sample reservoir 3211 to separate the sample reservoir 3211 into a first portion A1 and a second portion A2 as shown, for example, in FIGS. 11 and 12. The first portion A1 is above the retention screen 3221 and the second portion A2 is below the retention screen 3221 and contains one or more solid reagents (e.g., R1, R2, R3 shown, for example, in FIGS. 11 and 12). In this manner, the retention screen 3221 limits the movement of the solid reagents. In particular, the solid reagents are limited from exiting the input opening 3212 and the sample input opening 3021 by the retention screen 3221 (e.g., during shipment, storage, or use). The retention screen 3221 allows the sample preparation module 3200 to receive a biological sample and to mix the biological sample with the solid reagents R1, R2, R3 to form an input solution containing a target molecule within the input reservoir 3211. Although three solid reagents R1, R2 and R3 are shown, a different number of solid reagents can be used. For example, in some embodiments, two solid reagents are used that include: a control mechanism reagent and an N-acetylcysteine (NAC-P) reagent. In some embodiments, four sold reagents are used. For example, a reverse transcription enzyme reagent (RT) reagent, a RT primer reagent, a control organism (e.g., MS2) and an RNas Inhibitor, and a NAC-P.

Specifically, the retention screen 3221 defines one or more apertures 3222. The one or more apertures 3222 are sized to allow the biological sample to flow through the retention screen 3221 from the first portion A1 of the input reservoir 3211 to the second portion A2 of the input reservoir 3211. In one example, the apertures 3222 are large enough to allow the biological sample to flow through the retention screen 3221 from the first portion A1 into the second portion A2. Additionally, or alternatively, the apertures 3222 are large enough to allow a mixing fluid (e.g., air and their bubbles in the biological sample as discussed herein) to flow from the second portion A2 into the first portion A1. The one or more apertures 3222 are sized to limit the ability of the solid reagents (e.g., R1, R2, R3) within the second portion A2 of the input reservoir 3211 from exiting the input reservoir 3211 via the sample input opening 3021. Specifically, the apertures 3222 are small enough to retain the solid reagents (e.g., R1, R2, R3) within the second portion A2. For example, the aperture area is less than the solid reagent cross section.

In alternative embodiments of a test device, an input retention lid 3224 may not be included. In some such embodiments, a separate retention screen component can be included and coupled within the sample reservoir 3211. For example, a retention screen can be included that is similar to or the same as the retention screen shown and described in International PCT Publication No. WO2023/018896 incorporated by reference herein. FIG. 23 is an illustration of a portion of a test device 5000 that does not include the input retention lid 3224. The test device 5000 includes a sample preparation module 5200 that includes a base 5210, a flexible heater 5230 and a carrier 5233 that can be the same as the base, flexible heater and carrier of test device 3000. For example, the base 5210 includes a wall that defines a sample reservoir 5211. The flexible heater 5230 is partially immersed within the sample reservoir 5211, and the carrier 5233 is coupled to and supports the flexible heater 5230 on the base 5210 without contacting the wall of the base 5210. The test device 5000 can also include any of the components and functions described herein for other test devices.

As described above, when the lid 3050 is in the opened position, a biological sample can be conveyed into the input reservoir 3211 via the sample input opening 3212. The input reservoir 3211 is a volume within which the biological sample can be mixed with reagents and also heated. For example, in some embodiments the biological sample can be collected in the input reservoir 3211 and mixed with either or both of a control organism and a reverse transcriptase reagent. The control organism and the reverse transcriptase can each be lyophilized or otherwise in solid form. Moreover, the reagents R1, R2 and R3 can be secured within the input reservoir 3211 with the retention screen 3221 to prevent the reagents R1, R2 and R3 from inadvertently falling out of the test device 3000, for example during storage, transportation, or use.

In some embodiments, the sample preparation module 3200 contains two reagents, R1 and R2. The reagent RI is a positive control organism, such as Aliivibrio fischeri, N. subflava, or any other suitable organism. Specifically, Aliivibrio fischeri is suitable because it is gram negative, nonpathogenic, bio safety level 1, not harmful to the environment, and is extremely unlikely to be found on a human. The positive control surface within the detection module contains capture probes for both the control organism (e.g., A. fischeri) as well as each of the target organisms. This arrangement ensures that the positive control surface always produces color if the device functions correctly. If only the control organism were present, a very strong positive for one of the target organisms could “swamp out” or “outcompete” the amplification of the control organism during PCR. Under such circumstances, the positive control spot would not produce a color change which would be confusing for the user. This arrangement facilitates the detection method and the device 3000 being operated by a user with minimal (or no) scientific training, in accordance with methods that require little judgment.

In some embodiments, the reagent R2 contains the reverse transcriptase enzymes and other constituents to facilitate the RT-PCR methods described herein. For example, in some embodiments, the reagent R2 includes the salts needed to create the correct buffering environment for the RT-PCR. In some embodiments, the reagent R2 can include one or more reducing agents. In some embodiments, the reducing agent is lithium, sodium, potassium, aluminum amalgam, lithium aluminum hydride, sodium borohydride, sodium cyanoborohydride, lithium tri-butoxy aluminum hydride, dibutoxy aluminum hydride, lithium triethyl borohydride, tris(2-carboxyethyl) phosphine (TCEP), dithiothreitol (DTT), mercaptoethanol, cysteine, thioglycolic acid, cysteamine, glutathione, N-acetylcysteine (NAC), β-mercaptoethanol, sodium dodecyl sulfate (SDS), sodium sulfite, ammonium sulfamate, sodium bisulfite, dithionite metabisulfite sulfur dioxide, vitamin C, ascorbic acid, dimethylsulfoxide (DMSO), or any combination thereof. In some embodiments, the dried particles comprise NAC.

The reagents are formulated to dissolve in the biological sample within the input reservoir 3211. In some embodiments, the mixing can be enhanced by any of the methods described in PCT International Publication NO. WO2023/018896 incorporated by reference above. In some embodiments, air can be conveyed into the input reservoir 3211 to mix the biological sample and the reagents R1, R2, R3 therein. Specifically, upon actuation of the test device 3000, air can be conveyed from the fluidic drive module 3400 through the inlet opening 3212, and into the input reservoir 3211. The air can be present in the fluidic drive module 3400 and the valve assembly (not shown) can be placed into a configuration to allow this retrograde flow of air into the sample reservoir 3211. The air can be conveyed at a rate and for a time period sufficient to facilitate dissolution and/or mixing of the solid reagents within the biological sample. For example, in some embodiments, the air can be conveyed in a manner to produce bubbles and/or turbulence with the second portion A2 of the sample reservoir 3211.

In accordance with some embodiments, the mixing in the sample reservoir 3211 between the biological sample and the solid reagents can be passive and additionally or alternatively include active mixing. In one example of active mixing, the fluid is injected into the sample reservoir 3211 for a suitable time to mix the biological sample and the solid reagents R1, R2, R3 such that when the solution is pulled from the sample reservoir 3211 the reagents are mixed into the biological sample in concentrations that remain generally consistent through the process. In one example, the air pushed through the sample reservoir 3211 between 10-30 μL/s. In one example, the air is pushed through the input reservoir 3211 at between 15-25 μL/s. In one example, the air is pushed through the sample reservoir 3211 at about 20 μL/s.

As described herein, the apertures 3222 of the retention screen 3221 can be sized to permit the air to vent from the second portion A2. Moreover, the cover surface 3057 of the lid 3050 is spaced apart from the sample reservoir 3211 thereby forming an air gap between the lid 3050 and the sample reservoir 3211 through which the air can be vented. As discussed above, the lid 3050 does not seal closed the housing opening 3021 and/or the sample input opening 3212. This air gap can limit pressurization of the sample reservoir 3211 when the test device 3000 is active, thereby allowing flow of air into the sample reservoir 3211 to enhance mixing.

In some embodiments, the biological sample can be heated within the input reservoir 3211 using the heater 3230 to lyse the cells within the biological sample and further lyse (or release) the target RNA from any viruses contained with the biological sample. In other words, the biological sample can be heated to both break apart the cells and also disrupt the viruses therein to release target RNA for detection. The heater 3230 can maintain the biological sample at any suitable temperature and for any of the time periods described herein. For example, in some embodiments, the biological solution can be maintained at a temperature within a lysing temperature range to release a ribonucleic acid (RNA) molecule. The lysing temperature range can be, for example, between about 25 C and about 70 C. In other embodiments, the lysing temperature range can be between about 25 C and about 50 C. The methods of temperature measurement and control described herein can allow for the device to accurately control the sample temperature to achieve the desired reactions.

The sample preparation module 3200 also includes a mixing assembly (not shown) that is used to mix the PCR reagents with the biological sample to conduct an amplification reaction. The mixing assembly can be the same as or similar to and function the same as or similar to the mixing assembly described in PCT International Application No. WO/2023/018896 incorporated by reference above. In some embodiments, the mixing assembly is configured to produce and/or convey a sufficient volume of liquid for the amplification module 3600 to provide sufficient volume output to the detection module 3800.

After being mixed within the mixing assembly, the prepared sample is then conveyed to the amplification module 3600. The transfer of fluids, including the reverse transcription solution, the reagents or the like is caused by the fluidic drive (or transfer) module 3400. The fluidic drive (or transfer) module 3400 can be a pump or series of pumps configured to produce a pressure differential and/or flow of the solutions within the diagnostic test device 3000. Similarly stated, the fluid drive module 3400 is configured to generate fluid pressure, fluid flow and/or otherwise convey the biological sample and the reagents through the various modules of the device 3000. The fluid drive module 3400 is configured to contact and/or receive the sample flow therein. Thus, in some embodiments, the device 3000 is specifically configured for a single-use to eliminate the likelihood that contamination of the fluid drive module 3400 and/or the sample preparation module 3200 will become contaminated from previous runs, thereby negatively impacting the accuracy of the results. The fluid drive module 3400 can be a piston pump that is coupled to the reagent module. The fluid drive module 3400 can be driven by and/or controlled by the electronic control module 3950. For example, in some embodiments, the fluid drive module 3400 can include a stepper motor, the position of which can be controlled using rotary encoders (not shown). In other embodiments, the processor (e.g., processor 2951) of the electronic control module 3950 can include code to and/or be configured to implement a closed loop method of tracking motor position by monitoring the current draw of motor, as described in International Patent Publication No. WO2016/109691, entitled “Devices and Methods for Molecular Diagnostic Testing.”

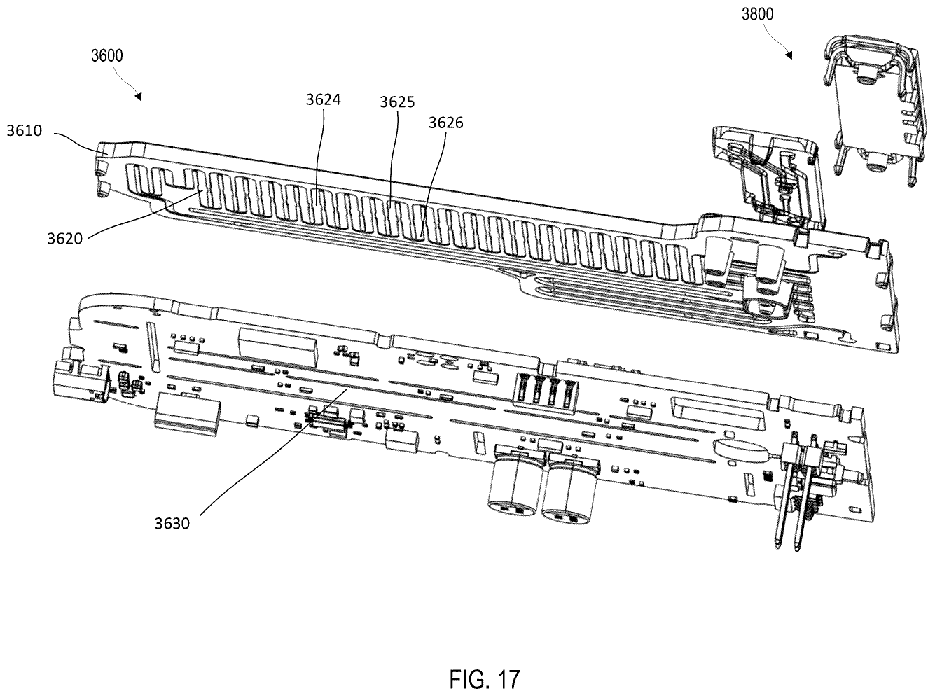

The amplification module 3600 can be the same as or similar to and function the same as or similar to the amplification module described in PCT International Application No. WO/2023/018896 incorporated by reference above. For example, as shown in FIGS. 17-19, the amplification module 3600 can include a flow member 3610, a heater 3630, and a heat sink 3690. The flow member 6610 can be any suitable flow member that defines a flow path 3620 within which the prepared solution can flow and/or be maintained to amplify the target nucleic acid molecules within the solution. As shown, the amplification flow path 3620 has a curved, switchback or serpentine pattern. The serpentine arrangement provides a high flow length while maintaining the overall size of the amplification module 3600 within the desired limits. Moreover, the serpentine shape allows the flow path 3620 to intersect the heater 3630 at multiple locations. In this manner, distinct “heating zones” are defined throughout the flow path 3620 so that the amplification module 3600 can perform a “flow through” PCR when the sample flows through multiple different temperature regions. Specifically, the flow path 3620 is shaped and/or has a geometry such a first portion 3625, a second portion 3626, and a third portion 3624 can be maintained at different temperatures by the heater 3630. Specifically, the heater 3630 is coupled to the flow member 3610 to establish a “hot” temperature zone (which includes the third (or central) portion 3624 of the flow path 3620) and two “cold” temperature zones (which include the first portion 3625 and the second portion 3626). The hot temperature zone can be maintained at a temperature of about 90 degrees Celsius to allow the sample flowing therethrough to be denatured. The cold temperature zone can be maintained at a temperature of about 60 degrees Celsius to allow the sample flowing therethrough to be annealed.

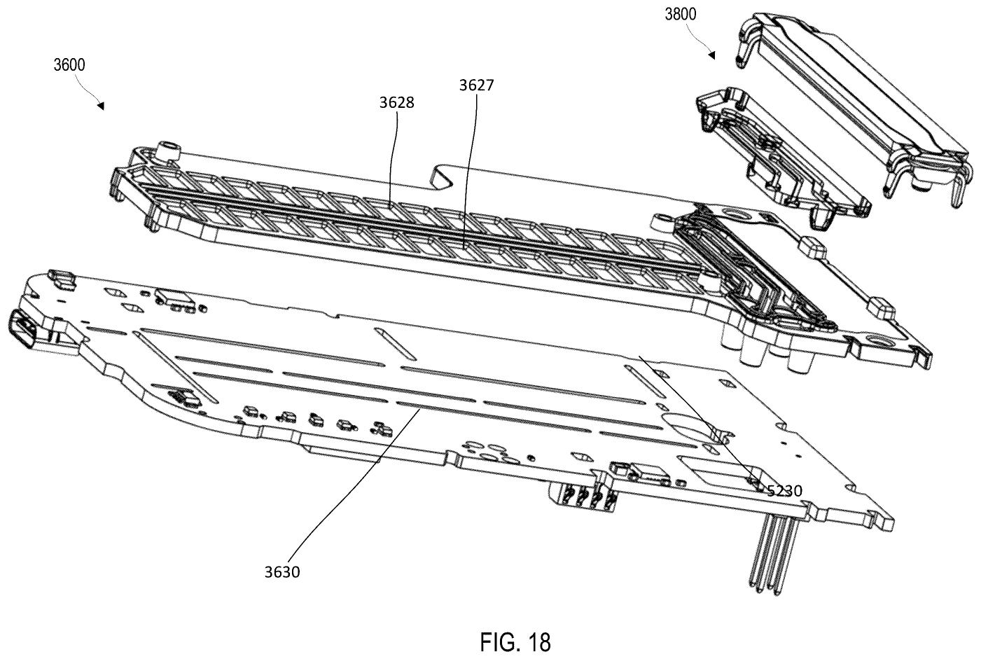

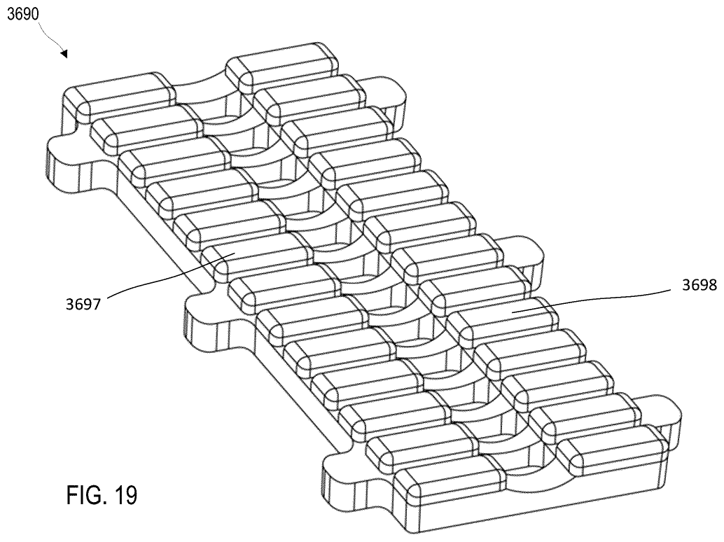

As shown in FIGS. 18 and 19, the upper portion of the flow member (i.e., the portion opposite from where the heater 3630 is coupled) defines a first set of recesses 3627 that is aligned with (or corresponds to) the first portion 3625 of the flow path 3620 and a second set of recesses 3628 that is aligned with (or corresponds to) the second portion 3628 of the flow path 3620. The first set of recesses 3627 is configured to receive the corresponding protrusions 3697 of the heat sink 3690 and the second set of recesses 3628 is configured to receive the corresponding protrusions 3698 of the heat sink 3690. In this manner, the heat sink 3690 can be matingly coupled to the flow member 3610 to improve the heat transfer away from the two cold temperature zones. As shown in FIG. 19, the central portion of the heat sink 3690 has a set of openings and/or recess, which are selected to reduce the couple to the hot temperature zone (i.e., the portion aligned with the third portion 3624 of the flow path). In this manner, the flow member 3610 and the heat sink 3690 can be configured to produce a higher heat flow away from the two cold temperature zones to reduce the likelihood that the temperature in these zones will exceed the desired set point.

The heat sink 3690 can be constructed from any suitable material that provides the desired heat capacity (e.g., specific heat), mass and/or thermal conductivity. For example, in some embodiments, the heat sink 3690 can be constructed from a thermoplastic elastomer. In such embodiments, the upper portion of the flow member (i.e., the portion opposite from where the heat sink 3690 is coupled to the flow member 3610) can be in contact with the inner surface of the top housing 3010. Moreover, because the thermoplastic elastomer is compressible, the heat sink 3690 can be compressed between the flow member 3610 and the top housing 3010, thereby securing the heat sink 3690 in place without the need for fasteners and also maintaining a secure thermal connection for improved heat transfer properties. In other embodiments, the heat sink 3690 can be constructed from nylon, glass-filled nylon, and polycarbonate.

The heater of the amplification module 3600 can be any suitable heater or collection of heaters that can perform the functions described herein to amplify the prepared solution. For example, in some embodiments, the amplification module 3600 (or any of the amplification modules described herein) can be similar to the amplification modules shown and described in U.S. Patent Publication No. 2017/0304829 entitled “Printed Circuit Board Heater for an Amplification Module,” which is incorporated herein by reference in its entirety. In some embodiments, the heater can establish multiple temperature zones through which the prepared solution flows and/or can define a desired number of amplification cycles to ensure the desired test sensitivity (e.g., at least 30 cycles, at least 34 cycles, at least 36 cycles, at least 38 cycles, or at least 60 cycles). The heater (and any of the heaters described herein) can be of any suitable design. For example, in some embodiments, the heater can be a resistance heater, a thermoelectric device (e.g., a Peltier device), or the like. In some embodiments, the heater can be one or more linear “strip heaters” arranged such that the flow path crosses the heaters at multiple different points. In other embodiments, the heater can be one or more curved heaters having a geometry that corresponds to that of the flow member to produce multiple different temperature zones in the flow path.

Although the amplification module 3600 is generally described as performing a thermal cycling operation on the prepared solution, in other embodiment, the amplification module 3600 can perform any suitable thermal reaction to amplify nucleic acids within the solution. In some embodiments, the amplification module 3600 (and any of the amplification modules described herein) can perform any suitable type of isothermal amplification process, including, for example, Loop Mediated Isothermal Amplification (LAMP), Nucleic Acid Sequence Based Amplification (NASBA), which can be useful to detect target RNA molecules, Strand Displacement Amplification (SDA), Multiple Displacement Amplification (MDA), Ramification Amplification Method (RAM), or any other type of isothermal process.

The detection module 3800 is configured to receive output from the amplification module 3600 and reagents from the reagent module 3700 to produce a colorimetric change to indicate presence or absence of target organism in the initial input solution. The detection module 3800 also produces a colorimetric signal to indicate the general correct operation of the test (positive control and negative control). In some embodiments, color change induced by the reaction is easy to read and binary, with no requirement to interpret shade or hue. The detection module 3800 can be similar to the detection modules shown and described in International Patent Publication No. WO2016/109691, entitled “Devices and Methods for Molecular Diagnostic Testing” and in International Patent Publication No. WO2023/018896 each of which is incorporated herein by reference. As shown in FIGS. 17 and 18, the detection module 3800 can directly coupled to the flow member 3610 of the amplification module 3600.

As described above, the test device 3000 also includes a fluid transfer valve (not shown). The fluid transfer valve can be a disc type valve described in International Patent Publication No. WO2023/018896 incorporated herein by reference. The fluid transfer valve can alternatively be a linear type valve. The valve assembly can be moved between various different configurations, depending on the position of the valve body. For example, the valve assembly can be in a home (or initial position), in which a sample inlet path and a sample outlet path, as well as the other fluid connection/vent ports, are closed. The valve assembly can be moved to a first position, in which the sample inlet path and the sample outlet path are opened. With the valve assembly in the first position, actuation of the fluidic drive module 3400 (in a first direction) can produce a flow of air in a first (or retrograde) direction through a serpentine flow channel and into the input reservoir 3211 to facilitate an initial mixing operation, as described above. With the valve assembly in the first position, actuation of the fluidic drive module 3400 (in a second direction) can produce a flow of the biological sample in a second direction from the input reservoir 3211 into and through the serpentine flow channel and then to the mixing assembly. In this manner, the device 3000 can perform the RT-PCR methods as described herein. Moreover, the timing of the valve actuation and the power supplied to the fluidic drive module 3400 (e.g., the pump) can be controlled by the electronic control module 3950 to maintain the flow rate through the sample preparation module 3200 (including the serpentine channel) within a range that the desired performance for the RT-PCR can be achieved.

After completion of the mixing process within the mixing assembly, the valve assembly can be further moved into the second position (not shown). When the valve is in the second position, an amplification path is opened, thus allowing transfer of the mixed solution (i.e., post RT) to be conveyed into the amplification module 3600. The timing of the valve actuation and the power supplied to the fluidic drive module 3400 (e.g., the pump) can be controlled by the electronic control module 3950 to maintain the flow rate through the amplification module 3600 within a range that the desired performance for the amplification can be achieved. Moreover, with the valve assembly in the second position, continued actuation of the fluidic drive module 3400 will convey the amplified solution into and through the detection module 3800.

As described herein, the detection operation is accomplished by conveying a series of reagents into the detection module at specific times. Although closing the lid 3050 actuates the reagent module 3700 to open (or release) the reagents from their respective sealed containers, the reagents remain in the reagent module 3700 until needed in the detection module 3800. When a particular reagent is needed, the valve opens the appropriate vent path (e.g., a wash solution vent path, a detection enzyme vent path, and a detection substrate vent path) to the reagent module 3700. Actuation of the fluidic drive module 3400 applies vacuum to the output port of the reagent module 3700 (via the detection module 3800), thus conveying the selected reagent from the reagent module 3700 into the detection module 3800. The valve assembly can be moved to a third position, in which the detection enzyme vent path is opened. With the valve assembly in the third position, actuation of the fluidic drive module 3400 can produce a flow of the detection enzyme into the detection module 3800. The valve assembly can be moved to a fourth position, in which the wash solution vent path is opened. With the valve assembly in the fourth position, actuation of the fluidic drive module 3400 can produce a flow of the wash (or multi-purpose wash/blocking) solution into the detection module 3800. The valve assembly can be moved to a fifth position, in which the detection substrate vent path is opened. With the valve assembly in the fifth position, actuation of the fluidic drive module 3400 can produce a flow of the substrate into the detection module 3800. The valve assembly can be moved to a final position, in which the vent paths are closed.

As described above, the test device 3000 can be used to perform any of the methods described herein. Referring to FIGS. 20A-20C, to use the device, a biological sample S1 is first placed into the sample input opening 3021 (e.g., using a sample transfer pipette 110). The lid 3050 is then moved to the closed position, as shown by the arrow KK in FIG. 20B. The test device 3000 is then plugged in via the power cord 3905 to couple the device 3000 to a power source. For example, as shown in FIG. 21 and described above, the top housing 3010 includes an opening 3038 to receive a USB power cord (or other suitable power cord) to connect to a power input port 3039 of the test device 3000. In this manner, the test device 3000 can, in addition to disposing the sample therein and plugging in the device, be actuated by a single action (i.e., the closing of the lid). As described above, closing the lid 3050 encloses the sample reservoir 3211, actuates the electronic control module 3950 (and/or the processor included therein), and also actuates the reagent module 3700. In some embodiments, the device 3000 can perform any of the methods of detecting the connection of a USB Type-C connector to an electronic device, as described herein. In the manner, the device 3000 can accommodate any limitations on power or current that might be imposed by the USB-C protocol.

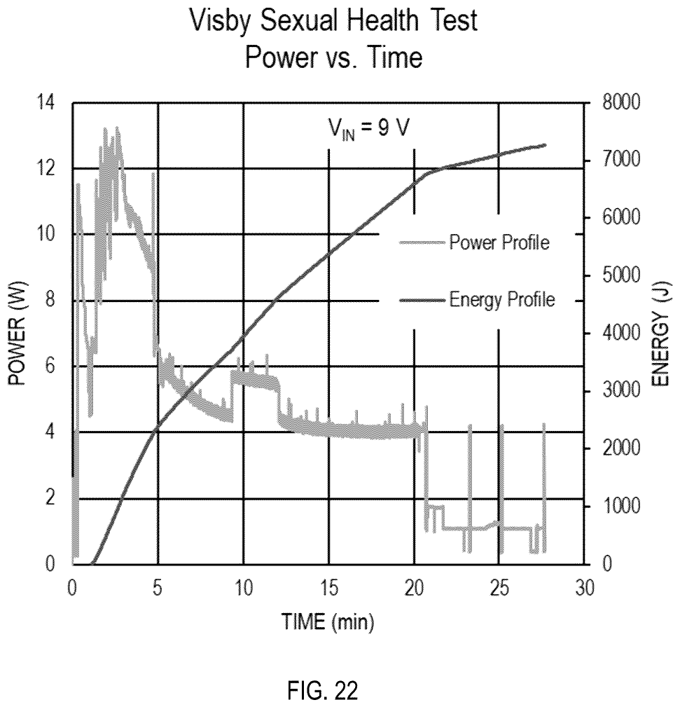

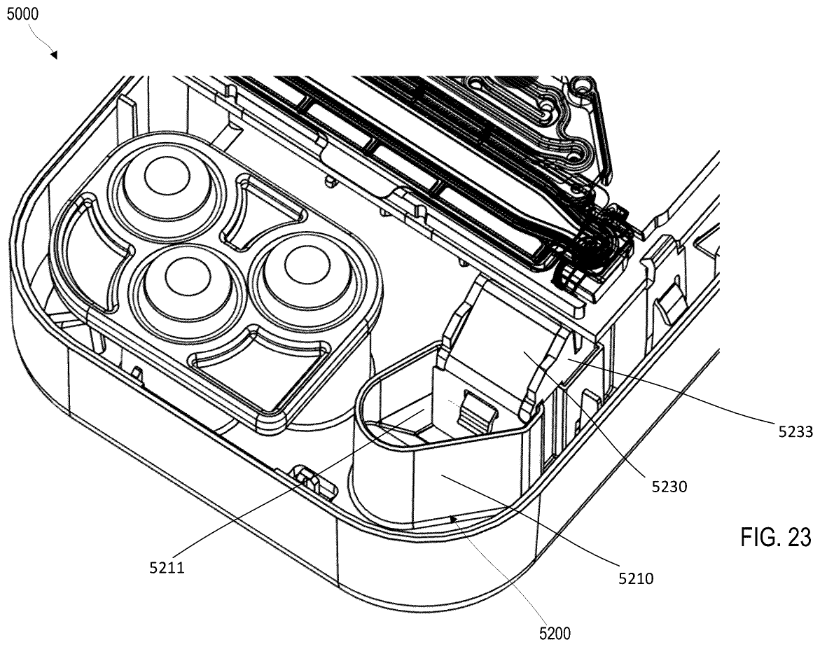

In some embodiments, the heaters (e.g., heater 3230 or the amplification heaters) of the test device 3000 can be controlled with a pulse width modulated (PWM) signal, according to any of the methods described herein. In this manner the electronic control module 3950 can either apply or remove power to the heating element(s) to ensure that the power or current draw during operation is maintained within the desired limits. Similarly stated, in some embodiments, the test device 3000 can be configured to selective operate one or more groupings of heating elements to reduce the likelihood of exceeding the maximum current draw, which could cause an undesired shutdown of the test. For example, FIG. 22 is a graph illustrating an example power and energy consumption versus time of a USB-C connector coupled to a molecular diagnostic test device.

While various embodiments have been described above, it should be understood that they have been presented by way of example only, and not limitation. Where methods and/or schematics described above indicate certain events and/or flow patterns occurring in certain order, the ordering of certain events and/or flow patterns may be modified. While the embodiments have been particularly shown and described, it will be understood that various changes in form and details may be made.

For example, any of the sample input modules, sample preparation modules, amplification modules, heater assemblies, and detection modules shown and described herein can be used in any suitable diagnostic device. Such devices can include, for example, a single-use device that can be used in a point-of-care setting and/or in a user's home. Similarly stated, in some embodiments, the device (and any of the other devices shown and described herein) can be configured for use in a decentralized test facility. Further, in some embodiments, any of the sample input modules, sample preparation modules, amplification modules, heater assemblies, and detection modules shown and described herein can be included within a CLIA-waived device and/or can facilitate the operation of a device in accordance with methods that are CLIA waived. Similarly stated, in some embodiments, the sample input modules, the sample preparation modules, the amplification modules, and the detection modules shown and described herein can facilitate operation of a device in a sufficiently simple manner that can produce results with sufficient accuracy to pose a limited likelihood of misuse and/or to pose a limited risk of harm if used improperly. In some embodiments, the sample input modules, the sample preparation modules, the amplification modules, and the detection modules shown and described herein can be used in any of the diagnostic devices shown and described in International Patent Publication No. WO2016/109691, entitled “Devices and Methods for Molecular Diagnostic Testing.”

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices.

Examples of computer code include, but are not limited to, micro-code or microinstructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The processor included within a control module (and any of the processors and/or controllers described herein) can be any processor configured to, for example, write data into and read data from the memory of the controller, and execute the instructions and/or methods stored within the memory. Furthermore, the processor can be configured to control operation of the other modules within the controller (e.g., the temperature feedback module and the flow module). Specifically, the processor can receive a signal including temperature data, current measurements or the like and determine an amount of power and/or current to be supplied to each heater assembly, the desired timing and sequence of the piston pulses and the like. For example, in some embodiments, the controller can be an 8-bit PIC microcontroller, an ARM Cortex M0+ or other suitable controllers, which will control the power delivered to various heating assemblies and components within the amplification module. This microcontroller can also contain code for and/or be configured to minimize the instantaneous power requirements on the power source.

In other embodiments, any of the processors described herein can be, for example, an application-specific integrated circuit (ASIC) or a combination of ASICs, which are designed to perform one or more specific functions. In yet other embodiments, the microprocessor can be an analog or digital circuit, or a combination of multiple circuits.

Any of the memory devices described herein can be any suitable device such as, for example, a read only memory (ROM) component, a random access memory (RAM) component, electronically programmable read only memory (EPROM), erasable electronically programmable read only memory (EEPROM), registers, cache memory, and/or flash memory. Any of the modules (the pressure feedback module and the position feedback module) can be implemented by the processor and/or stored within the memory.

Although various embodiments have been described as having particular features and/or combinations of components, other embodiments are possible having a combination of any features and/or components from any of embodiments as discussed above.

What is claimed is:

1. An apparatus, comprising:
a housing;
a sample preparation module disposed within the housing, the sample preparation module having a base including a wall defining a sample reservoir;
a flexible heater having a first end and a second end, the first end of the heater coupled to a connector to be in electrical communication with a power source; and
a carrier coupled to and supporting the flexible heater such that the second end of the flexible heater is disposed within the sample reservoir, spaced apart from the wall.

2. The apparatus of claim 1, wherein:
the carrier includes a coupling portion and a tab, the coupling portion coupling the carrier to the base, the tab coupled to the second end of the flexible heater to support the flexible heater spaced apart from the wall of the base.

3. The apparatus of claim 2, wherein:
the flexible heater defines an opening, a portion of the tab of the carrier is received through the opening of the flexible heater.

4. The apparatus of claim 3, wherein:
the sample preparation module further includes an input retention lid, the input retention lid defines an opening in a side wall of the input retention lid, the portion of the tab of the carrier is received through the opening of the input retention lid.

5. The apparatus of claim 2, wherein:
the base defines an opening, a portion of the coupling portion of the carrier is received through the opening of the base to couple the carrier to the base.

6. The apparatus of claim 1, wherein the flexible heater is devoid of a sensor component.

7. The apparatus of claim 1, wherein the sample reservoir is devoid of a sensor component.

8. The apparatus of claim 1, further comprising:
an electronic circuit system including a processor, the processor configured to measure a resistance change of the flexible heater to approximate a change in temperature within the sample reservoir, the processor configured to adjust a current supplied to the flexible heater based on the approximated change in temperature.

9. The apparatus of claim 1, further comprising:
an amplification module including an amplification heater.

10. The apparatus of claim 1, wherein the flexible heater includes a flexible circuit and a plastic sheath covering the flexible circuit.

11. A method, comprising:
introducing a biological sample into a sample reservoir of a sample preparation module, the sample preparation module having a wall defining the sample reservoir;
actuating a flexible heater disposed within the sample reservoir to heat the biological sample;
measuring, with a processor coupled to the flexible heater, a resistance change of the flexible heater;
approximating, with the processor, a change in temperature within the sample reservoir based on the measured resistance change of the flexible heater; and
adjusting with the processor a current supplied to the flexible heater based on the approximating the change in temperature.

12. The method of claim 11, wherein the measuring a resistance change of the flexible heater is performed during a first time period, the resistance change is first resistance change and the change in temperature is a first change in temperature, the method further comprises:
measuring with the processor during a second time period after the first time period, a second resistance change of the flexible heater; and
approximating a second change in temperature within the sample reservoir based on the measured second resistance change of the flexible heater.

13. The method of claim 12, wherein the adjusting the current supplied to the flexible heater is performed at a first adjustment time, the method further comprising:
adjusting with the processor at a second adjustment time a current supplied to the flexible heater based on the approximating a second change in temperature.

14. The method of claim 12, further comprising:
comparing the second resistance change to a preset temperature change value; and
on a condition that the second resistance change is equal to or greater than the preset temperature change value, supplying a constant current to the flexible heater to maintain a temperature of the flexible heater constant.

15. The method of claim 11, wherein:
the measuring a resistance change of the flexible heater includes after actuating the flexible heater, measuring a first current and a first voltage of the flexible heater;
based on the first current and the first voltage, calculating a first resistance of the flexible heater; and
comparing the first resistance to a stored resistance value to determine the resistance change of the flexible heater.

16. A method, comprising:
coupling a USB connector to an electronic device;
measuring at the electronic device a voltage across a configuration channel (CC) pin resistor of the electronic device;
identifying at the electronic device a power capability of the USB connector based on the measured voltage across the CC pin resistor; and
enabling at the electronic device, based on the power capability, an electronic load switch to make power from the USB connector available to the electronic device.

17. A method, comprising:
coupling a USB Type-C connector to an electronic device;
receiving at a first comparator a first voltage of a first configuration channel (CC) pin associated with the USB Type-C connector and a reference voltage, on a condition that the first voltage exceeds the reference voltage, the first comparator outputting a first signal;
receiving at a second comparator a second voltage of a second CC pin associated with the USB Type-C connector and the reference voltage, and on a condition that the second voltage exceeds the reference voltage, the second comparator outputting a second signal;
receiving at a logical OR gate, an output from the first comparator and an output from second comparator;
on a condition that the logical OR gate receives one of the first signal and the second signal, producing via the logical OR gate an output voltage;
receiving at an R-C time delay circuit, the output voltage of the logical OR gate; and
on a condition that the output voltage received at the R-C time delay circuit exceeds a threshold voltage, enabling an electronic load switch of the electronic device such that power from the USB Type-C connector becomes available to the electronic device.

18. The method of claim 17, wherein:
on the condition that the logical OR gate receives one of the first signal and the second signal, the logical OR gate increases the output voltage from 0 volts to 5 volts.

19. The method of claim 18, further comprising:
measuring at an analog to digital converter (ADC) pin, the first voltage and the second voltage;
determining at the ADC pin a power of the USB Type-C connector available to the electronic device based on the first voltage and the second voltage; and
on the condition that the power is determined to be less than 15 Watts, outputting a signal indicating that the power is insufficient.
